(19) United States
(12) Patent Application Publication
(10) Pub. No.: US 2007/0192867 A1
(43) Pub. Date: Aug. 16, 2007

(54) Security appliances

(76) Inventor: Gary S. Miliefsky, Tyngsboro, MA (US)

Correspondence Address: STRATEGIC PATENTS P.C.., C/O PORTFOLIOIP, P.O. BOX 52050, MINNEAPOLIS, MN, 55402, US

(21) Appl. No.: 11/338,870

(22) Filed: Jan. 23, 2006

Related U.S. Application Data
(63) Continuation-in-part of application No. 10/898,900, filed on Jul. 26, 2004.
(60) Provisional application No. 60/646,336, filed on Jan. 21, 2005.
(60) Provisional application No. 60/489,982, filed on Jul. 25, 2003.
(60) Provisional application No. 60/754,570, filed on Dec. 27, 2005.
(60) Provisional application No. 60/759,478, filed on Jan. 16, 2006.

(51) Int. Cl. G06F 11/00

(52) U.S. Cl. 726/25

(57) ABSTRACT

A security micro-appliance provides dynamic, reconfigurable threat protection. The micro-appliance may be deployed as a standalone system, or as a component in a distributed security system management from a central administrative location. In another aspect, a security appliance or micro-appliance employs RSS feeds and XML-based tests, alerts, and the like for monitoring and dynamic reconfiguration.

### RELATED APPLICATIONS

This application claims the benefit of, and incorporates by reference herein in its entirety, U.S. Provisional Patent Application No. 60/646,336, filed Jan. 21, 2005. This application also claims the benefit of, and incorporates by reference herein in its entirety, a U.S. Provisional Patent Application having attorney docket no. NETC-0001-P61, filed on Jan. 16, 2006 and entitled “MICRO-APPLIANCE FOR SECURITY AND VULNERABILITY MANAGEMENT.” This application also claims the benefit of, and incorporates by reference herein in its entirety, a U.S. Provisional Patent Application having attorney docket no. RSS-SECURITY-122105, filed on Dec. 21, 2005 and entitled “PROACTIVE NETWORK SECURITY USING REALLY SIMPLE SYNDICATION (RSS)”.

This application is a continuation-in-part of U.S. application Ser. No. 10/898900, filed on Jul. 26, 2004, the entire contents of which is incorporated herein by reference. That application also claims the benefit of U.S. Provisional Application No. 60/489,982, filed on Jul. 25, 2003, the entire contents of which is also incorporated herein by reference.

### BACKGROUND

1. Field

The present invention relates to computer security, and more particularly to a micro-appliance for use in defending against common vulnerabilities and exploits.

2. Description of Related Art

For years, network administrators have been plagued by the issue of unauthorized users (hackers) and their exploits (rootkits, viruses, worms, backdoors, spyware, etc.) who gain entry to the network by probing for weaknesses or misrepresenting their intentions when asking to use certain network services, such as asking for a network user to read an email message. As such, it can be appreciated that anti hacker security system have been in use for years. Typically, anti hacker security systems are comprised of information security (INFOSEC) appliances that protect computers and computer-based networks against attacks from hackers. These appliances are typically sold as point-solutions and countermeasures ranging from Firewalls (FW), virtual private networks (VPNS) AntiVirus Servers (AVS), Anti Distributed Denial of Service (Anti-DDoS), Certificate Authorities (CA), Content Filtering and Application Caching (PROXY), Encryption Acceleration and Secure Sockets Layer (SSL), Intrusion Detection Systems (IDS), Intrusion Prevention Systems (IPS), Vulnerability Assessment (VA), Vulnerability Remediation (VR), and Wireless Security (802.11b) using Wireless Encryption Protocol (WEP) some of which may or may not be deployed with Clustering and High Availability (HA) features with Hardened Operating Systems (HOS) and well thought out, customer-tested Human Factors in Design (HFID).

The main problem with conventional anti-hacker security system is that they are not designed to stop hackers, instead they are countermeasures that react to threats. Thus, today's security systems still leave the network vulnerable to attack, although they are capable of addressing certain attacks once the attack is identified.

Another problem with conventional anti hacker security systems is that they are typically built as proprietary systems, resulting in long design, development and release cycles. This of course can be problematic as hackers release new attacks quite frequently, and because of the Internet, many of today's attacks spread with breathtaking speed from one network to another. In a world where attacks can spread from Asia to North America in a matter of days, it is important that security measures be deployed as quickly as possible. It is also important that the INFOSEC security measures be designed to scale more easily so that improvements in central processing unit (CPU) power, memory and storage can be made available on a regular basis. Unfortunately, most of today's INFOSEC solutions are hard to upgrade and manage. For example, many of today's INFOSEC appliances have been “hard wired” with a CPU, and thus over time may be unable to keep up with user demand. In fact, many INFOSEC systems today are “hard wired” with one or more network adapter interface for a 10 megabits per second network and if the network performance requirements move to 100 megabits per second or a gigabit per second, these INFOSEC appliances become bottlenecks to network performance and therefore detract from user productivity. Still another problem with conventional anti hacker security system are that each INFOSEC appliance has a completely different and unique administrative interface. After deploying more than a few of these appliances, it becomes extremely difficult for System Administrators (SYSADMINs) to manage these systems.

Thus, there is a need for improved security systems.

### SUMMARY

In one aspect, there is disclosed herein a security micro-appliance that provides dynamic, reconfigurable threat protection. The micro-appliance may be deployed as a standalone system, or as a component in a distributed security system management from a central administrative location. In another aspect, there is disclosed herein a security appliance or micro-appliance that employs RSS feeds and XML-based tests, alerts, and the like for monitoring and dynamic reconfiguration.

As used herein, it will be understood that the term security refers generally to vulnerability management, exploit management, intrusion detection, intrusion prevention, anti-spyware, smartswitch management, countermeasure deployment and management, and any other technologies and/or techniques useful in protection data integrity, privacy, security, and the like for computer-based assets and/or communications.

### BRIEF DESCRIPTION OF THE FIGURES

Various other objects, features and attendant advantages of the present invention will become fully appreciated as the same becomes better understood when considered in conjunction with the accompanying drawings, in which like reference characters designate the same or similar parts throughout the several views, and wherein:

FIG. 1 shows a hacker's view of computer-based assets connected to an internal and external network.

FIG. 2 shows layers of typical network security countermeasures designed to protect computer-based assets.

FIG. 3 depicts common entry points for hackers to attack computer-based assets.

FIG. 4 shows computer-based assets protected from internal and external attacks.

FIG. 5 is a view of the invention's approach to proactive network security to protect computer-based assets.

FIG. 6 is a architectural view of proactive network security system to protect against attacks by hackers.

FIG. 7 is a communication interface between the proactive network security and typical countermeasures.

FIG. 8 is a sample “open box” very small hardware device that the present invention can be deployed on.

FIG. 9 is a sample “open box” 1 u rack-mount generic server appliance with the present invention installed.

FIG. 10 (1) is a hardware reference design of the preferred embodiment.

FIG. 11 is a summary of the system architecture of the preferred embodiment.

FIG. 12 is an illustration of a branch office deployment of Security and Vulnerability Management Micro Appliance.

FIG. 13 is an illustration of the architectural integration of command center/dashboard (with data warehousing) and micro appliances on a Wide Area Network (WAN) with a secure data feed for multi-appliance correlation.

FIG. 14 is an illustration of the architectural integration of a command center/dashboard for multi-appliance correlation with SVM micro appliances.

FIG. 15 is a detailed view of the software engines operating with a command center/dashboard with micro appliances.

FIG. 16 is a sample command center display.

FIGS. 17A-17C show a reference design for security and vulnerability management on micro appliances.

FIG. 18 is an overview of the Open Vulnerability Assessment Language (OVAL).

FIG. 19 is an overview of a typical RSS Model used for news and content updates for consumers.

FIG. 20 is an overview of an RSS Model for machine-based automation addressing threats, alerts, vulnerability tests and related INFOSEC feeds for IT Staff and INFOSEC countermeasures.

FIG. 21 shows an RSS channel that may be used with a security system.

FIG. 22 shows an RSS channel element that may be used with a security system.

FIG. 23 is a detailed view of layers of a security subsystem architecture.

FIG. 24 shows an RSS-based security architecture.

FIG. 25 shows a database subsystem.

FIG. 26 shows an RSS-based updating system architecture.

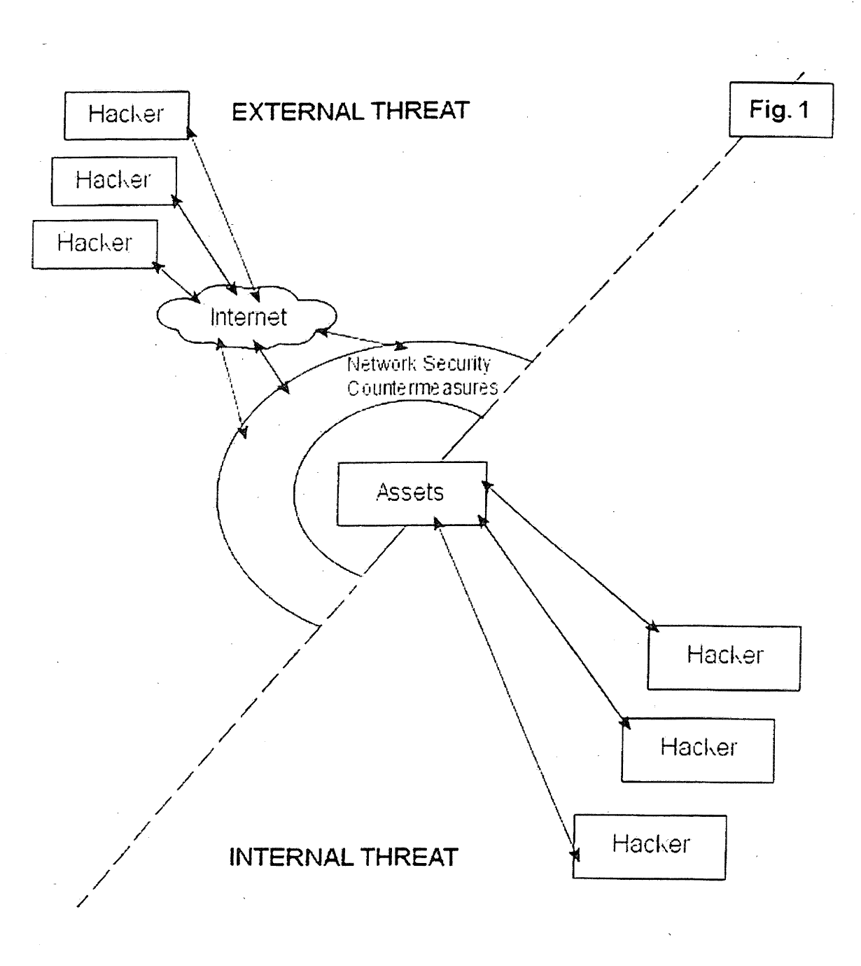

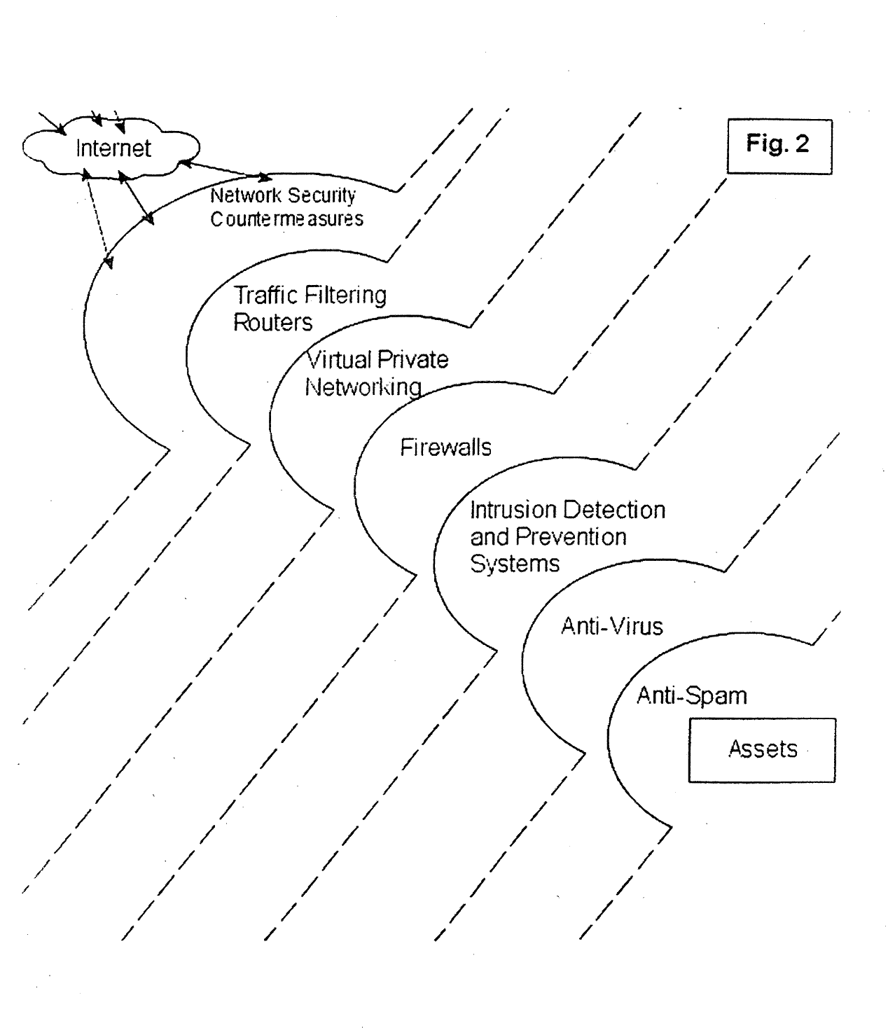

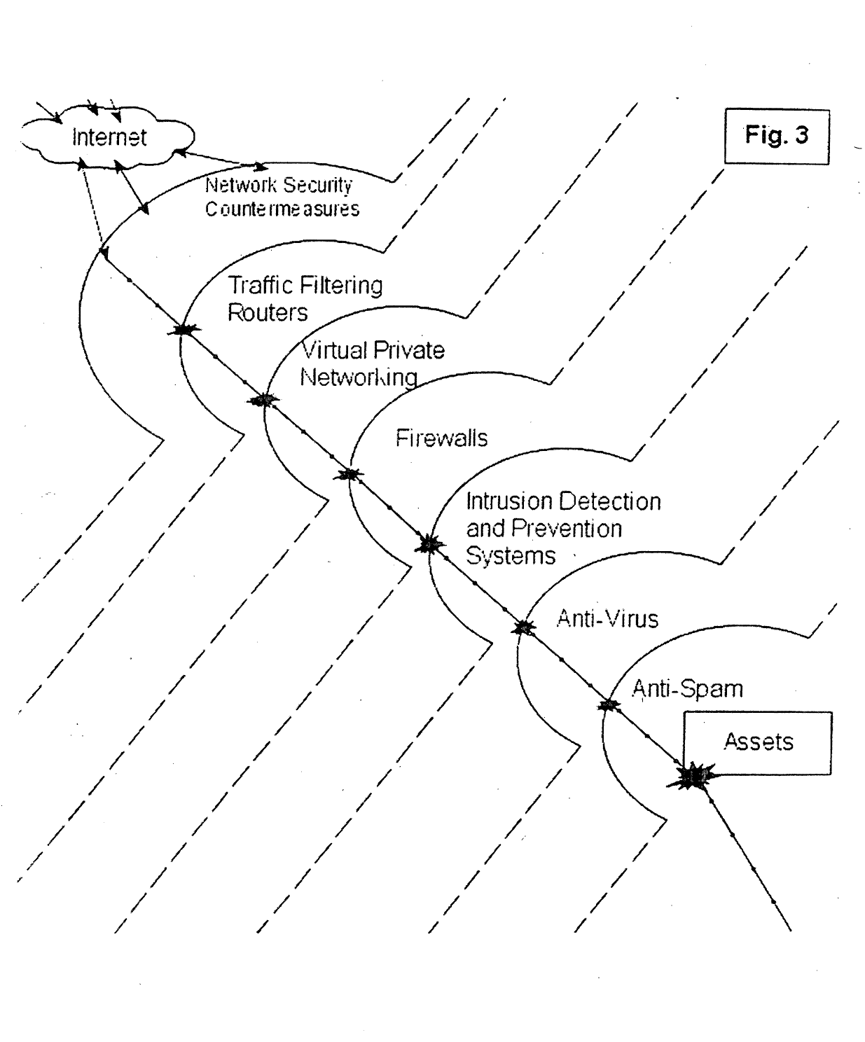

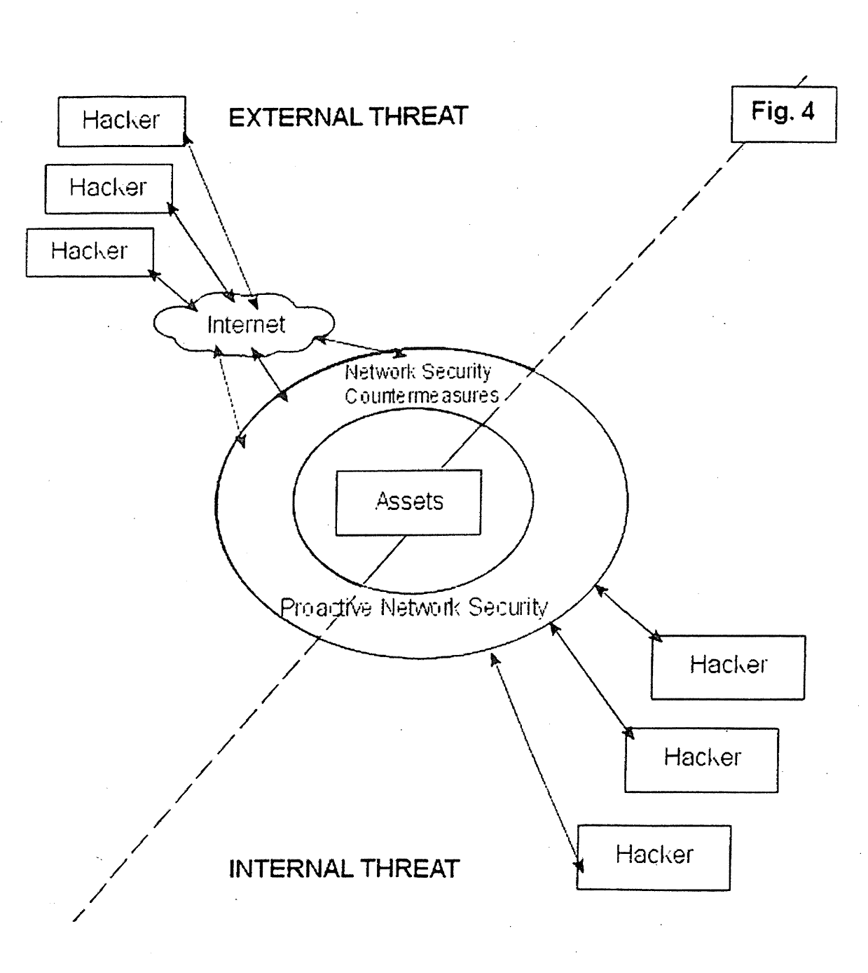

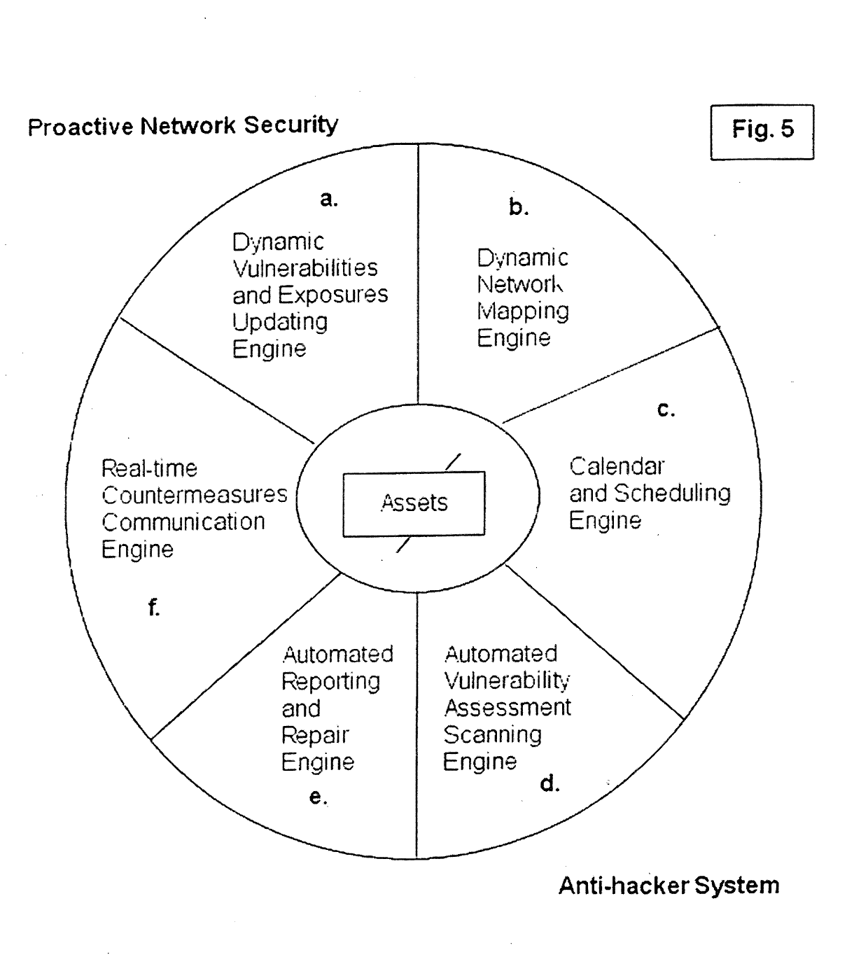

### DETAILED DESCRIPTION OF THE PREFERRED EMBODIMENT(S)

The system and methods described herein include, among other things, security systems that provide proactive automated defense against hackers by automatically finding, reporting, communicating with countermeasures about and removing the common vulnerabilities and exposures (CVEs) that they exploit. Accordingly, the systems described herein provide for proactive security by determining the components that exist on a network system and generating a list of network assets.

In one embodiment, the invention provides a security method that can be executed on a wired and/or wireless network. As part of the security method, in a first step the network is scanned and/or probed for any and all attached equipment and related assets, herein referred to as “network-based” assets. The method will dynamically detect and map changes to LAN and WAN connected equipment including searching for equipment which may be deemed as rogue and creating a network-based assets list, wherein the list contains information as to the location of the network-based assets.

The list may contain information as to the Internet Protocol (IP) address of said network-based assets, and the list may contain information as to the open Ports of said network-based assets and related application, session, transport, sockets and other internet protocol (IP) related information. The list may contain other information such as the Media Access Control (MAC) address of said network-based assets, whether the connection is Wired or Wireless of said network-based assets and other information about the structure of the network and its component devices.

The information contained in the list may change automatically and at pre-scheduled intervals as network-based assets are moved or relocated.

In a further step, the method audits one or more of the network-based assets for common vulnerabilities and exposures (CVEs) as defined by the U.S. federally funded CVE list managed by MITRE corporation or any similar list. The method will generate a CVE and related regulatory compliance audit reports and update the CVE and related regulatory compliance audit tests. In a further step the method can share MAC, IP, Port, CVE and related regulatory compliance other related audit data with various INFOSEC countermeasures designed to help protect network-based assets against attacks.

The method may then activate an INFOSEC engine to update plugins to ensure the system continues to stay current with methodologies to protect against hackers in a proactive way.

The method defines a true risk profile for the computer-based network environment, and uses the knowledge of external and internal CVEs as well as how to manage and remediate against these CVEs, to provide more robust and proactive security.

The attached figures illustrate a proactive network security system to protect against hackers, which comprises a human factors in design (HFID) graphical user interface (GUI) for secure configuration and administration, a DYNAMIC UPDATES engine, an INFOSEC engine, INFOSEC engine PLUGINs and communications interface possibly including but not limited to one or more of the following: Firewalls (FW), virtual private networks (VPNS) AntiVirus Servers (AVS), Anti Distributed Denial of Service (Anti-DDoS), Certificate Authorities (CA), Content Filtering and Application Caching (PROXY), Encryption Acceleration and Secure Sockets Layer (SSL), Intrusion Detection Systems (IDS), Intrusion Prevention Systems (IPS), honeypot systems (HPS), Vulnerability Assessment (VA), Vulnerability Remediation (VR), and Wireless Security (802.11b) using Wireless Encryption Protocol (WEP), Clustering and High Availability (HA) features with Hardened Operating Systems (HOS) and “open box” PC or generic server appliance hardware on which to deploy the invention, a human factors in design (HFID) graphical user interface (GUI) for secure configuration and administration, a software engine that can securely and dynamically update one or all components of the INFOSEC ENGINE and/or all INFOSEC ENGINE PLUGINs as well as other key security components of the invention, an Information Security (INFOSEC) software engine that acts as a gateway between users, personal computers, servers, services and the computer network (internet, intranet, extranet, wide area network, wireless network or local area network), an Information Security (INFOSEC) software component that plugs into the INFOSEC engine to expand the INFOSEC capabilities of the solution. Sample PLUGINs may include one or more of the following but not limited to Firewalls (FW), virtual private networks (VPNS) AntiVirus Servers (AVS), Anti Distributed Denial of Service (Anti-DDoS), Certificate Authorities (CA), Content filtering and Application Caching (PROXY), Encryption Acceleration and Secure Sockets Layer (SSL), Intrusion Detection Systems (IDS), Intrusion Prevention Systems (IPS), Vulnerability Assessment (VA), Vulnerability Remediation (VR), and Wireless Security (802.11b) using Wireless Encryption Protocol (WEP), Clustering and High Availability (HA). The system uses an operating system that has been hardened against known weaknesses and attack methodologies of hackers. The system has a software component that enables the INFOSEC Engine to be deployed on more than one OPEN-BOX HARDWARE systems that can act as one single INFOSEC Engine through a computer network. The system may also employ a software component that acts like a human “heart-beat” between two or more INFOSEC appliances and enables one appliance to takeover for another should the other malfunction, any Personal Computer (PC) or generic server appliance that can run the Windows or Linux operating systems. A client-server modular based software system for secure, authenticated and non-repudiable communications between the Proactive Network Security system and any traditional or typical Countermeasures System to increase the probability that a hacker will not be able to break into the existing network infrastructure through automated vulnerability assessment, reporting, and remediation.

A human factors in design (HFID) graphical user interface (GUI) for secure configuration and administration may be provided. The Secure Graphical User Interface (GUI) is accessible through non-repudiable means. One method is through an HTTPS (Secured HyperText Transfer Protocol-Secure Sockets Layer (SSL) enabled) Web Browser. At initial connection, an additional layer of security is available through a login (USERID/PASSWORD) dialog box. Once logged into the Secure GUI, an administrator is able to quickly and easily navigate through graphical buttons and hyperlink text. The navigation is optimized for the most rapid means of configuring, operating and managing an Anti-Hacker Proactive Network Security System. The structure of an optimized Secure GUI is dynamic in nature, based upon the modules, options and INFOSEC plugins which are loaded into the system. The functions include rapid access to the dynamic vulnerabilities and exposures updating engine to select when, if ever, to schedule updates to the system, the dynamic network mapping engine to initialize an automated scan and review of operating systems, hardware and software connected to the computer-based network, a calendar and scheduling engine with simple calendar and scheduling functions and views to allow for numerous configurations of the system, allowing the administrator to choose which computers or network equipment on Internet Protocol (IP) addresses to scan for vulnerabilities and to protect against hacker attacks, access to key features and configuration of the vulnerability assessment, access to key features and configuration of the reporting engine with data export functionality as well as the repair engine which enables an administrator to proactively choose automated repair or specialized repair on a per IP address or system basis and finally, control of the plugins and real-time countermeasures communications engine to enhance the automation of proactive network security functionality through communications with traditional countermeasures. The Secure GUI contains functions for reading and writing of configuration, reporting, management and remediation data.

A software engine can securely and dynamically update one or all components of the INFOSEC ENGINE and/or all INFOSEC ENGINE PLUGINs as well as other key security components of the invention. The dynamic updates engine will update the Anti-Hacker Proactive Network Security System with tests for the latest known common vulnerabilities and exposures (CVEs) as well as updates to the System software, as needed, including maintenance and security updates and full-system upgrade patches. The dynamic updates engine securely communicates with and authenticates to a remote updating service which may be hosted through a virtual private network or through a strong-encrypted web-based service running on a system which is publicly assessable through an IP Address and an HTTPS or other SSL-based connection. The Dynamic Updates Engine functions include requesting authentication and access to the updating service, requesting updates from the updating service, informing the updating service about system health and other non-privacy related system features and issues which may enable enhancements to the quality and proactive nature of the Anti-Hacker System. The updating engine is designed to as not to compromise true privacy and full confidentiality of the end-user for ethical and regulatory compliance issues.

An Information Security (INFOSEC) software engine acts as a gateway between users, personal computers, servers, services and the computer network (internet, intranet, extranet, wide area network, wireless network or local area network). The information Security (INFOSEC) Engine controls the computer-based network scanning, standards-based vulnerability assessment through common vulnerabilities and exposures (CVEs) testing, reporting and remediation as well as interfacing with the INFOSEC ENGINE PLUGINs. The INFOSEC Engine is structured in a modular fashion with a main controller that takes input for control from the Secure GUI modules. Functions include reading and acting upon the configuration and scheduling data as stored by the Secure GUI modules. The INFOSEC Engine contains a unique module for each vulnerability assessment CVE test as well as communication modules to enable non-intrusive testing for each unique IP Address accessible from the computer-based network. The INFOSEC Engine contains read, write and export functionality for vulnerabilities found and reported in various formats including but not limited to structured query language (SQL) databases and tables, portable document format (PDF), extensible markup language (XML), hypertext markup language (HTML), comma separated values (CSV) and Excel file format (XSL). The INFOSEC Engine, at initialization, is able to determine which CVE tests are available as well as which INFOSEC Engine Plugins are available and then to relay this information to the Secure GUI for administration, control and management.

An Information Security (INFOSEC) software component that plugs into the INFOSEC engine to expand the INFOSEC capabilities of the solution. Sample PLUGINs may include one or more of the following but not limited to Firewalls (FW), virtual private networks (VPNS) AntiVirus Servers (AVS), Anti Distributed Denial of Service (Anti-DDoS), Certificate Authorities (CA), Content Filtering and Application Caching (PROXY), Encryption Acceleration and Secure Sockets Layer (SSL), Intrusion Detection Systems (IDS), Intrusion Prevention Systems (IPS), Vulnerability Assessment (VA), Vulnerability Remediation (VR), and Wireless Security (802.11b) using Wireless Encryption Protocol (WEP), Clustering and High Availability (HA). The INFOSEC Engine Plugins each share a common communications interface with the INFOSEC Engine. They provide all necessary aspects of Information Security (INFOSEC) functionality, administration, reporting, management and remediation not originally built into the Anti-Hacker Proactive Network Security System so as to maintain currency with state-of-the-art INFOSEC functions and requirements. The INFOSEC Engine Plugins are unique in that they each may perform functionality ranging from vulnerability assessment, reporting, management and remediation to industry standard countermeasure functionality such as stateful packet inspecting firewall, virtual private networking through IP Security (IPSec), Secure Sockets Layer (SSL) to Intrusion Detection, Intrusion Prevention, Honeypot, Anti-Virus, to Anti-Spam and other countermeasure-based INFOSEC functionality not originally built-into the Anti-Hacker system design. These INFOSEC Engine Plugins may be securely and dynamically obtained and installed automatically or manually through the Dynamic Updates Engine.

An operating system may be employed that has been hardened against known weaknesses and attack methodologies of hackers. The Hardened Operating System is one which is deployed without any common vulnerabilities and exposures (CVEs) that a hacker might take advantage of to jeopardize the security of the Anti-Hacker Proactive Network Security System. All unnecessary functionality has been removed including but not limited to unnecessary open ports and unnecessary computer-based networking protocols, applications and system services. The Hardened Operating System may be Linux, BSD, Unix or Windows-based. It will provide all necessary functionality for the Anti-Hacker Proactive Network Security System software to function as designed but not allow for any unauthorized access to Operating System specific functionality by any administrator, end-user or unauthorized hackers.

A software component enables the INFOSEC Engine to be deployed on more than one OPEN-BOX HARDWARE systems that can act as one single INFOSEC Engine through a computer network. The Clustering software will enable multiple Anti-Hacker Proactive Network Security system computer-based network appliances which are within the same network to operate as a clustered system to share workload, as necessary for any and all functions which may be clustered such as network scanning, vulnerability assessment through CVE testing, reporting, remediation and other critical functionality that may be too CPU intensive for one system alone in a large network. The Structure of the Clustering is organic by nature and allows for multiple systems to communicate securely, sharing critical information related to any and all INFOSEC functions being performed. Functions include secure authentication and communication necessary to join a cluster, be removed from a cluster and operate as part of a cluster.

A software component acts like a human “heart-beat” between two or more INFOSEC appliances and enables one appliance to takeover for another should the other malfunction. High Availability of the Anti-Hacker Proactive Network Security System is achieved through human-like heart-beat patterns of bit sharing and clock synchronization of more than one system through one of many possible means including but not limited to IP-based communication over computer-based network cables, hubs, switches, routers or other devices or serial or USB connectivity with or without crossover cables as necessary. The High Availability component of the system is structured to enable automated recovery should one of multiple Anti-Hacker Proactive Network Security System appliances fail through hardware or software failure. Should this occur, the High Availability functions, operating in a background mode, regularly communicate as peers between two or more systems using peer-to-peer or client-server bit-based communications asking the age old question “Are you there?” and should a system not respond within a pre-defined and configurable period of time, the system asking the question will assume that the other system has failed and is offline. If a ping of the other system through computer-based networking does not achieve an acceptable response within an acceptable time-frame, the “live” system will takeover where the other system stopped. Functions to securely exchange system status and logs are run automatically during normal predefined and configurable schedules.

Any Personal Computer (PC) or generic server appliance may be employed that can run the Windows or Linux operating systems. The Anti-Hacker Proactive Network Security System may be deployed on any Open-Box Hardware. Open-Box Hardware is defined as any computer-based system that can operate standards-based software and operating systems included but not limited to Linux, BSD, Unix or Windows on Intel, AMD or compatible hardware systems. The Structure of the Open-Box Hardware can range from hand-held wired or wireless computer equipment to standard portable digital assistants (PDAs), laptops, desktops, servers or other computers. The functionality provided must include basis operating system, application and computer-based network connectivity.

A client-server modular based software system for secure, authenticated and non-reputable communications between the Proactive Network Security system and any traditional or typical Countermeasures System to increase the probability that a hacker will not be able to break into the existing network infrastructure through automated vulnerability assessment, reporting, and remediation. The Countermeasures Communications System enables secure communications between the Anti-Hacker Proactive Network Security System and other computer-based network equipment which may be newly designed or traditional INFOSEC countermeasure solutions such as stateful packet inspecting firewall, virtual private networking through IP Security (IPSec), Secure Sockets Layer (SSL) to Intrusion Detection, Intrusion Prevention, Honeypot, Anti-Virus, to Anti-Spam and other countermeasures-based INFOSEC functionality not originally built into the Anti-Hacker system design. The Countermeasure Communications System is structured to enable secure communications between the Anti-Hacker Proactive Network Security System and other computer-based network equipment which may be newly designed or traditional INFOSEC countermeasure solutions. Functions are available to initiate and terminate communications, allow the INFOSEC countermeasure client to initiate requests for scheduling or immediate vulnerability assessments through CVE tests, request reports in pre-defined file formats or a data feed of the results, request remediation on one, more or all of the IP Addresses which were tested or scheduled to be tested and to request dynamic updates to client INFOSEC countermeasure system.

The main components of one embodiment of this system are Open-Box Hardware, running a Hardened Operating System with optional Clustering and High Availability modules for flexible scalability and performance requirements and to preserve the longevity of hardware investments through expandability and reusability traditionally found in Open Box Computer-based hardware systems. Other key main components include the Dynamic Network Mapping Engine, Calendar and Scheduling Engine, Automated Vulnerability Assessment Scanning Engine, Automated Reporting, Exporting and Remediation Engine, Dynamic Update Engine and the Real-time Countermeasures Communications Engine. Subcomponents include the Secure Automated Repair Client, Countermeasures Communications Client, INFOSEC Engine Plugins and Computer-based Network stacks such as the TCP/IP or similar communications stack. Each component communicates as necessary through a multi-threaded non-blocking approach. The main components call the subcomponents as necessary as driven by the calendar and schedule which is read and managed by the INFOSEC engine, as established by the administrator through the Secure GUI. Alternative variations of this invention may include a network of one or more computers operating in parallel, in a grid or in very large, secure and remote clusters performing similar functionality and using a similar open-box hardware approach as well as accelerated proprietary chipsets which may or may not include accelerated PKI, SSL, IPSec, WEP and other INFOSEC protocols over wired or wireless networks.

In operation, the Hardware is attached to a computer-based network through the standard means of connectivity including but not limited to a wired or wireless TCP/IP connection. It is then rapidly configured by the Administrator through the secure GUI. Once configured, the system can optionally scan the locally accessible network to determine network topology and gather Operating System and IP Address information. Then, the Administrator can configure various scheduled events to enable the system to automatically scan various computer-based network equipment for a complete and thorough vulnerability assessment through common vulnerabilities and exposures (CVEs) tests. Optional INFOSEC Engine Plugins may be configured and managed through the Secure GUI, as well. Optional Countermeasure Communications may be configured either through the Secure GUI or remotely through the Administrative GUI of the integrated countermeasure system. Automated vulnerability reporting will result and the administrator will be notified as to which CVEs exist on which systems and simplified instructions on how to remediate for each of the CVEs found. Automated Remediation Clients may be deployed as agents running remotely on each system within the Computer-Based network. Theses Automated Remediation Clients will take their remediation instructions securely from the Anti-Hacker Proactive Network Security system or cluster of systems, under Administrator control either automatically, manually or a combination of both. Each remediated system will no longer contain the CVE that placed the system at risk of being breached by a Hacker and risking breaches of Regulatory Compliance, Legal Liability and the risk of damage to computer-based assets.

In an alternate embodiment, the invention provides methods for auditing one or more of said network-based assets for common vulnerabilities and exposures (CVEs) as defined by the U.S. federally funded CVE list managed by MITRE corporation or any similar list as managed by other open sources occurs through security auditing server-based software engine that has an ever-growing list of CVE tests which use network-based hacking methodologies of scanning, probing, fingerprinting and other remote security access methods to find vulnerable spots in the Internet protocol stack, TCP/IP, UDP or otherwise, operating system, user access or Internet-connected applications, server software and services that should be fixed. The results are stored and compared against each network-based asset list which is pre-processed in ASCII text format for storage into a simple text file, Comma Separated Value (CSV) file, Extensible Markup Language (XML) file and Structured Query Language (SQL) database table.

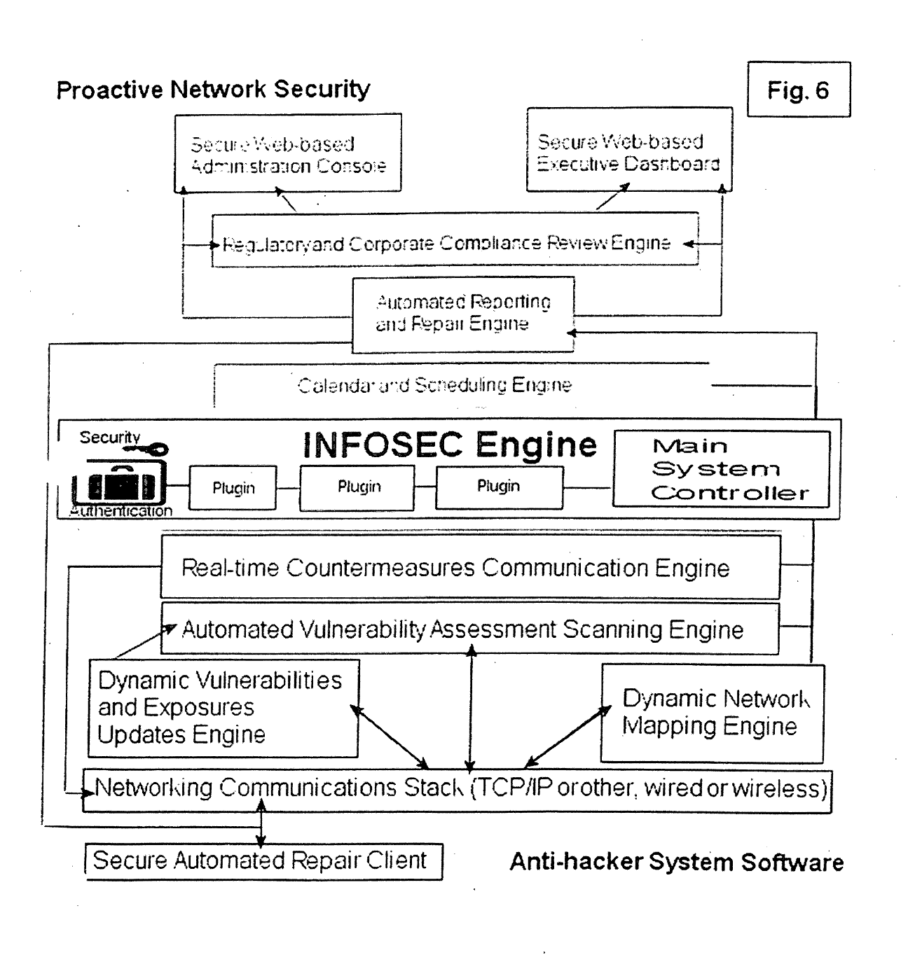

The method may automatically generate CVE and related regulatory compliance audit reports by taking the results of the CVE vulnerability assessment and security auditing system output and comparing each result against selected Regulatory and Corporate Compliance reviews including but not limited to any CVE which is found that may take a network-based asset out of said compliance through a weakness that creates risk of loss against non-repudiation and confidentiality of the network-based asset and all related data stored on the host of said network-based asset storage media. The method displays CVE test results in an easy to read format including conversion into HTML and PDF by reading the Comma Separated Value (CSV) file, Extensible Markup Language (XML) file and Structured Query Language (SQL) database table that hosts the CVE test results and regulatory compliance data. The method provides secure web-based GUI access to these reports by dynamically reading a list of all available CVE test results and their related reports into a simple selection list with a point and click interface for access by authorized administrators, through the Administration Console and by ‘C’ level executives through the Executive Dashboard interface (FIG. 6).

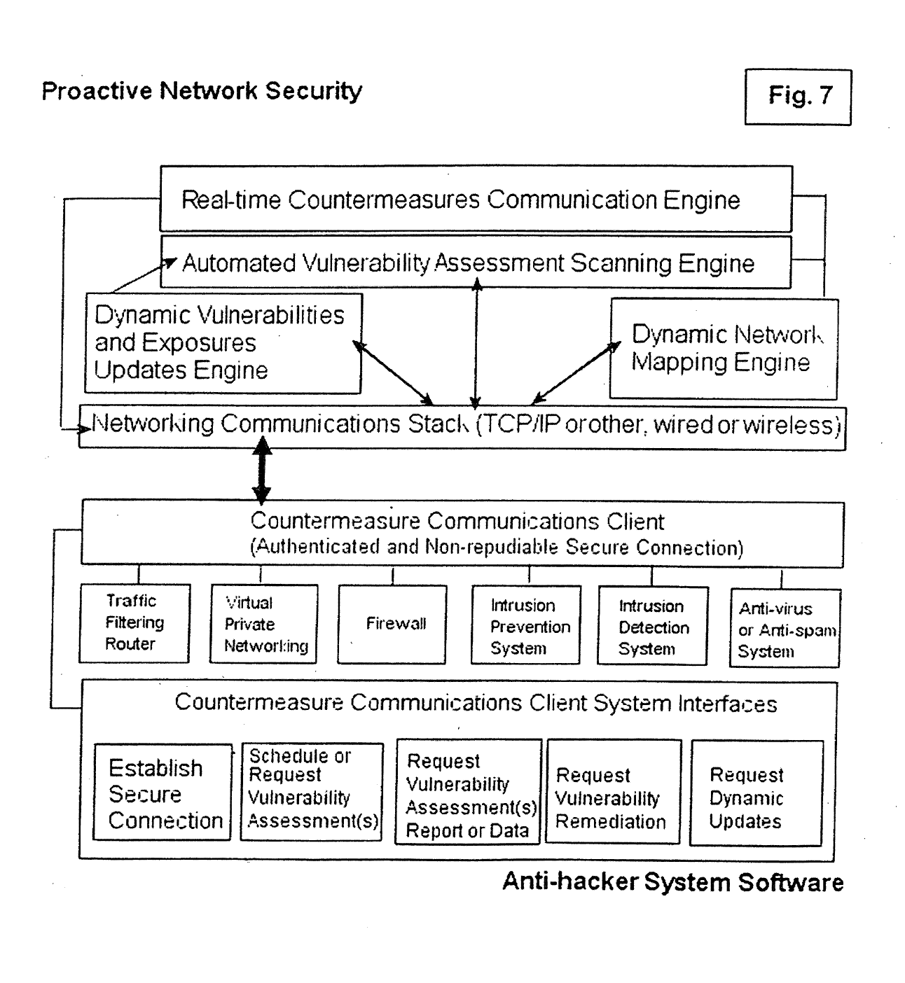

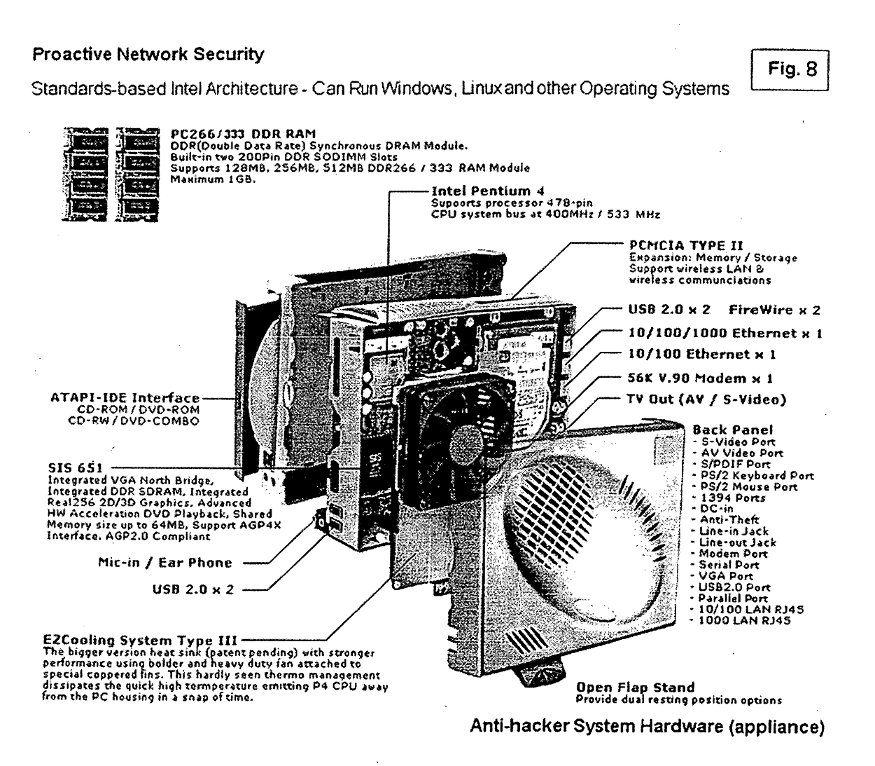

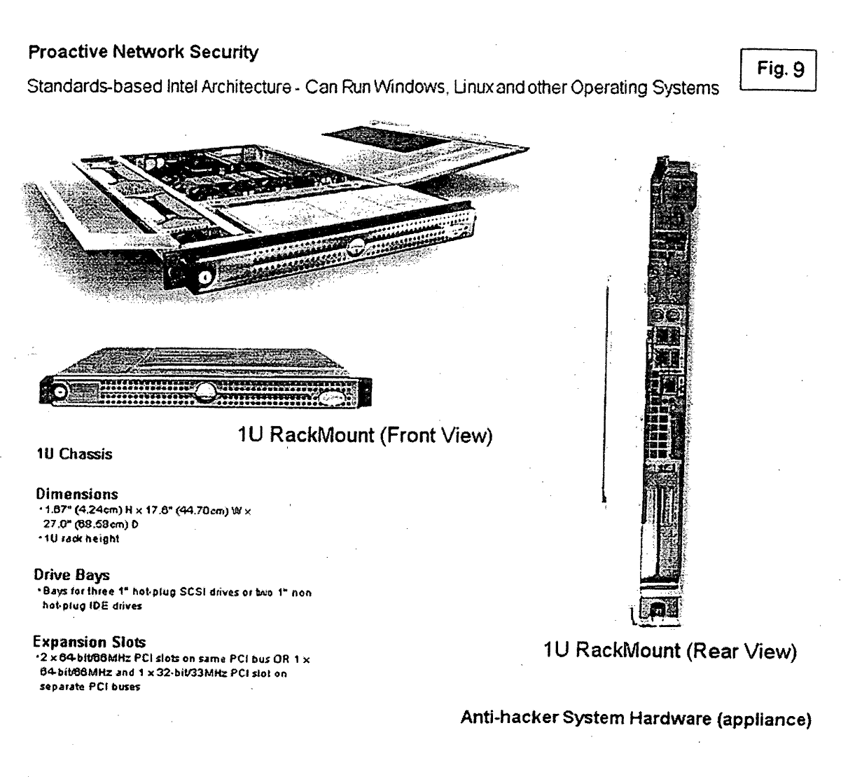

The method automatically shares MAC, IP, Port, CVE and related regulatory compliance other related audit data with various INFOSEC countermeasures including but not limited to traffic filtering routers, virtual private networking equipment, firewalls, intrusion detection systems, intrusion prevention systems, anti-virus solutions, anti-spam solutions, content proxies, honeypots and other countermeasures designed to help protect network-based assets against attacks through a Real-time Countermeasures Communication Engine (FIG. 7) which uses secure access through both authenticated and non-repudiable secure connections to said INFOSEC countermeasures.

Upon establishing a secure connection, the method shares MAC, IP, Port and other necessary network-based asset identification data with the INFOSEC countermeasure to create a relationship between the two systems. This provides the INFOSEC countermeasure with the most recent CVE test data available on the network-based asset to help an IT manager manually or automatically determine how the INFOSEC countermeasure should react to the CVE test data on each network-based asset which has known weak spots that are vulnerable to attack and pose a risk to the LAN and WAN should these Ports, protocols, client or server applications not be temporarily disabled, turned off or blocked from network access until patching or CVE remediation takes place through the Secure Automated Repair Client (FIG. 6) which may or may not be available and running on the network-based asset.

In the event the INFOSEC countermeasure is a firewall or traffic filtering router, dynamic alerting of the IT manager or an alternative alert recipient and dynamic changes to the firewall rule table will take place through the Countermeasure Communications Client plug-in which has been written for that MAKE, MODEL and VERSION firewall or traffic filtering router. This may temporarily disable, turn off, or block network access either granularly through Port related CVE data or non-granularly by blocking all traffic of the said network-based asset containing the CVE(s) which need remediation.

In the event the INFOSEC countermeasure is a VPN, dynamic alerting of the IT manager or an alternative alert recipient and dynamic changes to the VPN access list will take place through the Countermeasure Communications Client plug-in which has been written for that MAKE, MODEL and VERSION VPN. This can temporarily disable, turn off, or block network access either granularly through Port related CVE data or non-granularly by blocking all traffic of the said network-based asset containing the CVE(s) which need remediation.

In the event the INFOSEC countermeasure is an IPS, dynamic alerting of the IT manager or an alternative alert recipient and dynamic changes to the IPS access list will take place through the Countermeasure Communications Client plug-in which has been written specifically for that MAKE, MODEL and VERSION IPS. In the event the INFOSEC countermeasure is an IDS, dynamic alerting of the IT manager or an alternative alert recipient and sharing the related CVE tests data with the IDS to help the IDS reduce false positives in the IDS alerting module as well as reduce the traffic load related to intrusion detections which attack a particular IP address that is not susceptible to that particular attack methodology based upon the related CVE tests data and will take place through the Countermeasure Communications Client plug-in which has been written specifically for that MAKE, MODEL and VERSION IDS.

Upon establishing a secure connection, the method may obtain dynamic updates through a secure connection (SSL) of network-based asset risk profile data, vulnerability remediation data, asset management data, CVE test data, policy, and regulatory compliance data.

The method may also automatically update INFOSEC engine plugins to ensure the system continues to stay current with methodologies to protect against hackers. To this end, it establishes a secure connection through either SSL or HTTPS to obtain any and all available INFOSEC engine plugins that are not already installed on the Proactive Network Security appliance. The users may obtain these INFOSEC engine plugins through the ‘web-based’ human factors in design (HFID) graphical user interface (GUI) for system administrators, also known as an ‘administrative dashboard’ through electronic commerce (e-commerce) functionality. This e-commerce functionality, allows the users to view which INFOSEC engine plugins have been purchased, subscription service license status and transact purchases for any and all additional INFOSEC engine plugins which are available at the time of the users' connection to the Anti-Hacker Proactive Network Security e-commerce system, hosted securely on an SSL-enabled HTTPS web server, electronically shipping INFOSEC engine plugins which have been purchased, all related license keys and electronic documentation through an SSL tunnel, via secure file transfer (FTPS) or the secure hypertext transport protocol (HTTPS Get) functionality.

These INFOSEC engine plugins may include new interfaces to various countermeasures (i.e. Firewalls, VPNs, IDS and IPS), enhanced or new CVE auditing functionality, enhanced or new regulatory compliance reporting, enhanced or new policy building tools, enhanced auditing capabilities such as rogue wireless device detection, mobile device detection, updated database tables, updated GUI features and other ‘packaged’ enhancements to maintain currency of the system.

The method may allow for automatically repairing CVE and related regulatory compliance weaknesses through a client-server-based system tray (SYSTRAY) interface. The system may create secure SSL on-demand client-server communication interfaces between the SYSTRAY application running on client systems with one or more server ‘threads’ running on the Anti-hacker Proactive Network Security system on a per network-based asset basis, and upon establishing a secure connection, obtain patch management links, instructions, modules, executable patches and security fixes through an SSL tunnel, via secure file transfer (FTPS) or the secure hypertext transport protocol (HTTPS Get) functionality between the SYSTRAY client and the Anti-hacker Proactive Network Security system serve. The system may allow for executing links, instructions, modules, executable patches and security fixes from the SYSTRAY client application for repair and remediation of CVE and related regulatory compliance weaknesses of each CVE that has been uncovered by the Anti-hacker Proactive Network Security system for said network-based asset, on a per IP address basis.

A secure sockets layer (SSL), secure hypertext transport protocol (HTTPS), also known as ‘web-based’ human factors in design (HFID) graphical user interface (GUI) for system administrators, may be provided to support an ‘administrative dashboard’ that allows system administrators to access core functionality of the Anti-hacker Proactive Network Security system. This may include those functions necessary to manage, operate and update said system, and the administrative dashboard provides access to and control of initial licensing and setup by simple web-based form-fill and point-and-click operations.

The administrative dashboard provides access online help through mouse-over popup help as well as a hypertext markup language (HTML) help system available through simple point-and-click operations. The administrative dashboard provides access to and control of basic ‘headless appliance’ operations such as setting system date and time, remote update, reboot, shutdown by simple web-based point-and-click operations. The administrative dashboard provides access to and control of basic alerting operations such as alert through e-mail or pager module on operating system or Anti-hacker Proactive Network Security system tampering attempts. The administrative dashboard provides access to and control of advanced alerting operations such as alert through e-mail or pager module on completion of network-based asset discovery. The administrative dashboard provides access to and control of advanced alerting operations such as alert through e-mail or pager module on completion of CVE test completion on one or more selected network-based assets on a per IP address basis. The administrative dashboard provides access to and control of advanced alerting operations such as alert through e-mail or pager module on completion of system updates. The administrative dashboard provides access to and control of alerting operations such as alert through e-mail or pager module on unauthorized attempted login to the Anti-hacker Proactive Network Security system. The administrative dashboard provides access to and control of advanced alerting operations such as alert through e-mail or pager module on XML, Really Simple Syndication (RSS) or HTML news feeds for vulnerability alerts such as BUGTRAQ or other open-source vulnerability and hacker threat news feeds. The administrative dashboard provides access to and control of advanced alerting operations such as alert through e-mail or pager module on regulatory compliance reporting and related network-based asset risk profile. The administrative dashboard provides access to and control of network-based asset discovery, policy and countermeasure enforcement functionality by simple web-based point-and-click operations. The administrative dashboard provides access to and control of calendar and scheduling automation functionality for network-based asset discovery, policy and countermeasure enforcement functionality by simple web-based point-and-click operations. The administrative dashboard provides access to and control of system administrator level reporting of the CVEs discovered, CVE and countermeasure related event correlation and related regulatory compliance risks by simple web-based point-and-click operations. The administrative dashboard provides access to and control of policy building tools by simple web-based form-fill and point-and-click operations. The administrative dashboard provides access to and control of customer-service reporting, bug tracking and reporting and related issues reporting by simple web-based form-fill and point-and-click operations.

The systems described herein may use a secure sockets layer (SSL), secure hypertext transport protocol (HTTPS), also known as ‘web-based’ human factors in design (HFID) graphical user interface (GUI) for executives, also known as an ‘executive dashboard’. This allows executives such as a chief financial officer (CFO) or chief security officer (CSO) or chief information officer (CIO) to access of higher-level reporting functionality of the Anti-hacker Proactive Network Security system necessary to obtain CVE and regulatory related compliance reports, such as ‘You have X serious CVEs in your corporate network that may take you out of compliance with Y regulation’, CVE related countermeasure event alerts and high-level news feed alerts related to hacker, nationwide and worldwide hacker attack and/or new exploits, such as ‘BUGBEAR now attacking U.S. Corporate networks today at 0900 EST through Outlook flaw: CVE#xyz’, without overloading the executive with the detailed and granular data found in the administrative dashboard.

The executive dashboard provides access to and control of high level alerting operations such as alert through e-mail or pager module on serious risk of being out of compliance or having new CVEs discovered or detection of a rogue wired or wireless device in the network and/or Anti-hacker Proactive Network Security system subscription service about to expire. The executive dashboard provides access to and control of alerting operations such as alert through e-mail or pager module on unauthorized attempted login to the Anti-hacker Proactive Network Security system. The executive dashboard provides access to and control of which system administrators are allowed access to the Anti-hacker Proactive Network Security system.

An optional software component like a human ‘heart-beat’ between two or more Anti-hacker Proactive Network Security system INFOSEC appliances and enables one appliance to take over for another should the other malfunction. The usage of bit sharing and clock synchronization of more than one system through secure IP-based communications such as an SSL tunnel, via secure file transfer (FTPS) or the secure hypertext transport protocol (HTTPS Get) functionality over the LAN, WAN, or physically through serial, USB or crossover Ethernet cables to an extra network interface card (NIC) on each INFOSEC appliance. In the event serial, USB or crossover connections are used for heart-beat communications. The bit sharing and clock synchronization will occur through bit sharing and clock synchronization of two or more systems in a round-robin secure connection and data sharing. In the event one of the Anti-hacker Proactive Network Security system INFOSEC appliances does not provide a ‘heart-beat’ bit within a predetermined time frame, the next system to discover the lost ‘heart-beat’ will takeover where the lost, shutdown or physically damaged appliance left off by continuing any and all events which were last recorded and shared among ‘heart-beat’ enabled appliances through secure database replication.

As to further discussion of the manner of usage and operation of the present invention, the same should be apparent from the above description. Accordingly, no further discussion relating to the manner of usage and operation will be provided.

With respect to the above description then, it is to be realized that the optimum dimensional relationships for the parts of the invention, to include variations in size, materials, shape, form, function and manner of operation, assembly and use, are deemed readily apparent and obvious to one skilled in the art and all equivalent relationships to those illustrated in the drawings and described in the specification are intended to be encompassed by the present invention.

The security systems described above may be deployed on one or more micro-appliances, as described generally below. Thus there is disclosed herein a dynamically configurable security system using one or more micro-appliances. Each micro-appliance may comprise a small, solid state device that runs security software out of memory, such as random access memory. The device may include flash memory, compact flash (“CF”), flash read-only memory, flash random access memory, a microdrive, or the like, which may be externally removable (i.e., conveniently removable/replaceable by an end user through an external port). The device may store data locally, including assessments, security updates, network or computer asset status, and the like. This stored data may be transmitted to a centralized location such as a corporate headquarters or information technology center, where a dashboard or other management utility may be employed. The device may publish status and/or receive updates (either from a centralized management location, or from a public or commercial update service) concerning new vulnerabilities and/or exploits using, for example RSS or some other XML-based or other standard syntax. Updates may include reconfigurations, countermeasures, new policing or filtering algorithms, or the like relevant to the new vulnerabilities/exploits. In one embodiment, the micro-appliance may be deployed at a branch or remote location. The micro-appliance may operate as a standalone security system, or may function as a component in a distributed security system that communicates with an administrative center to provide local data and receive security updates.

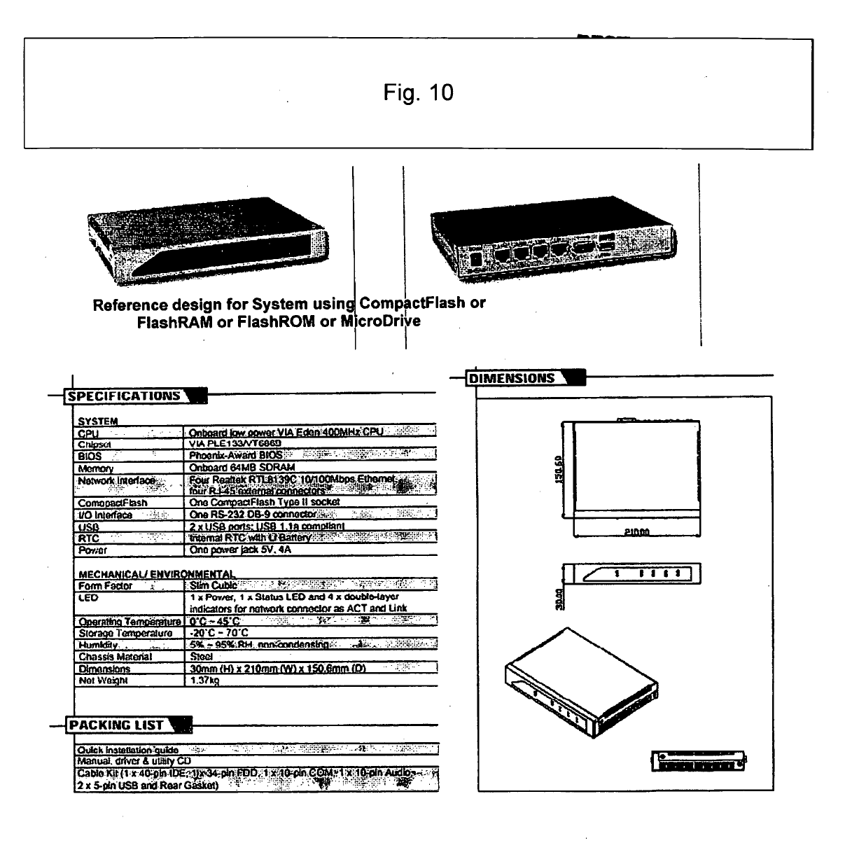

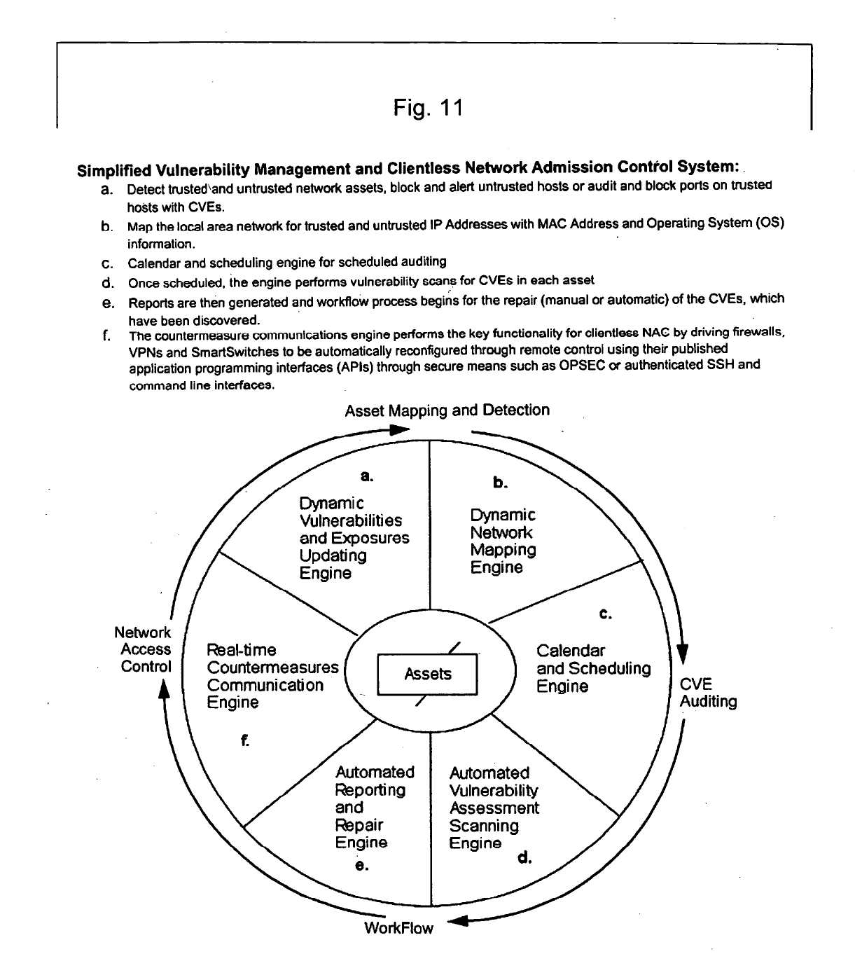

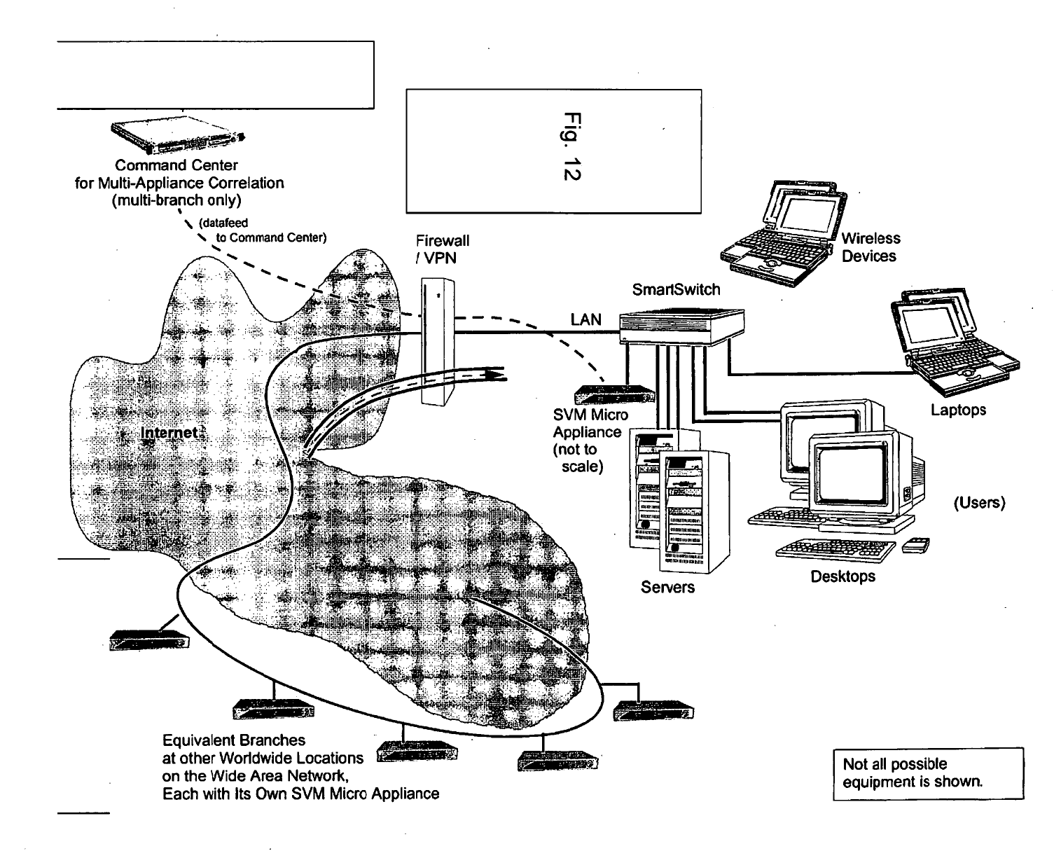

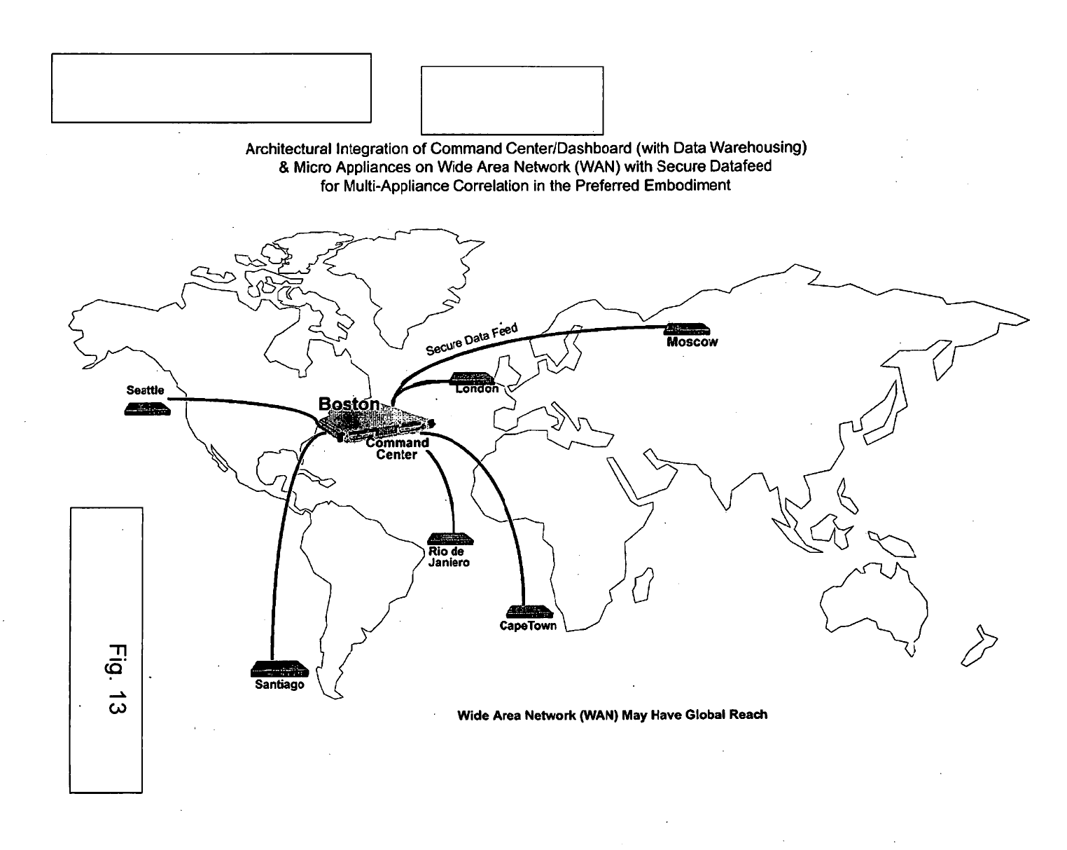

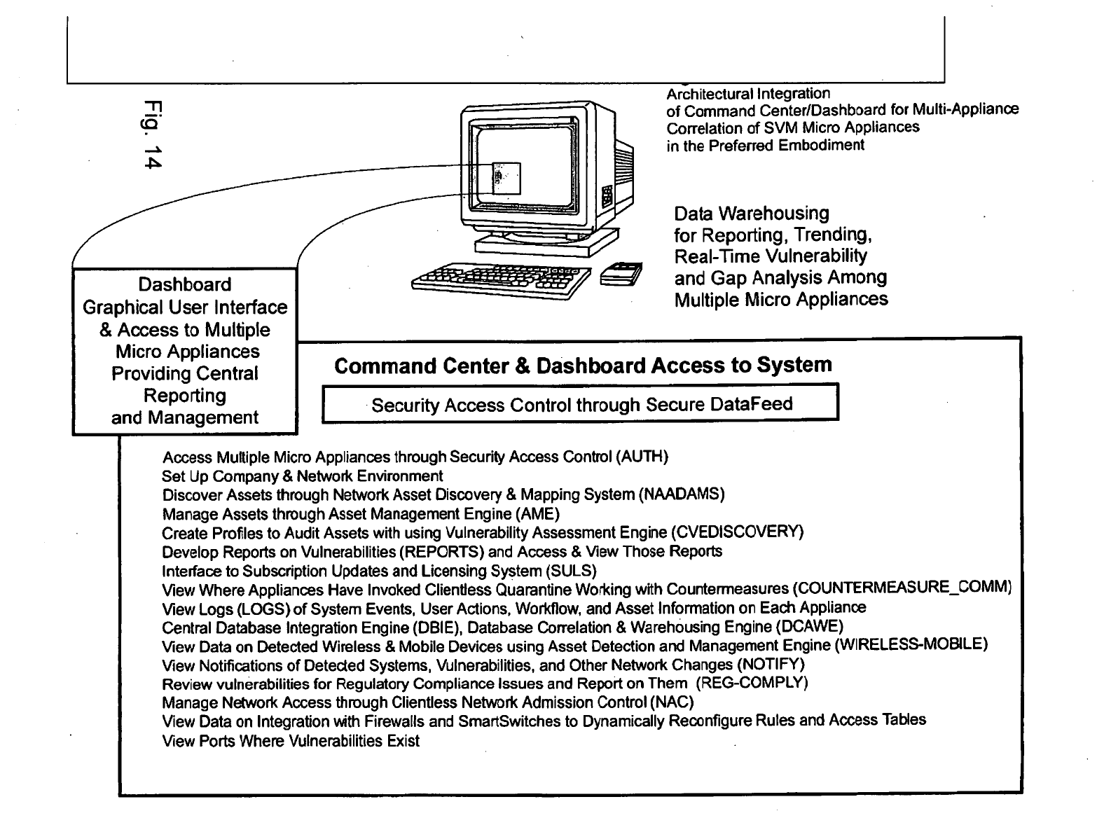

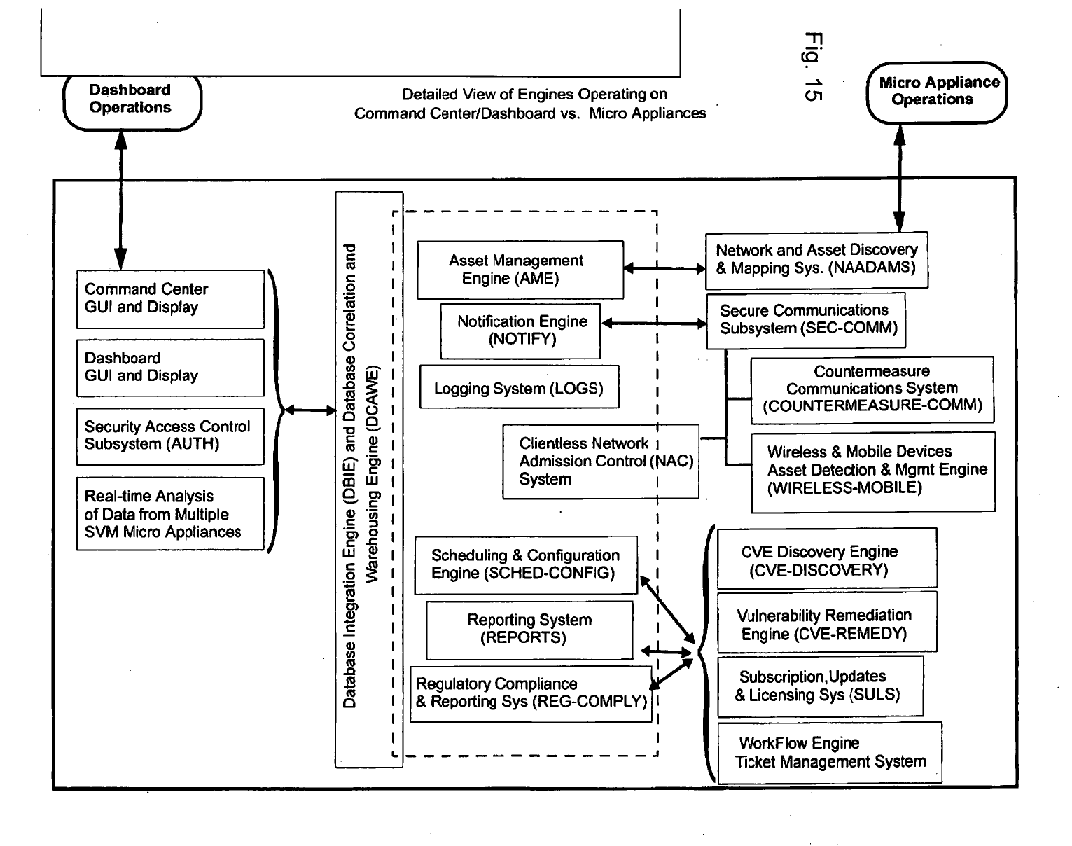

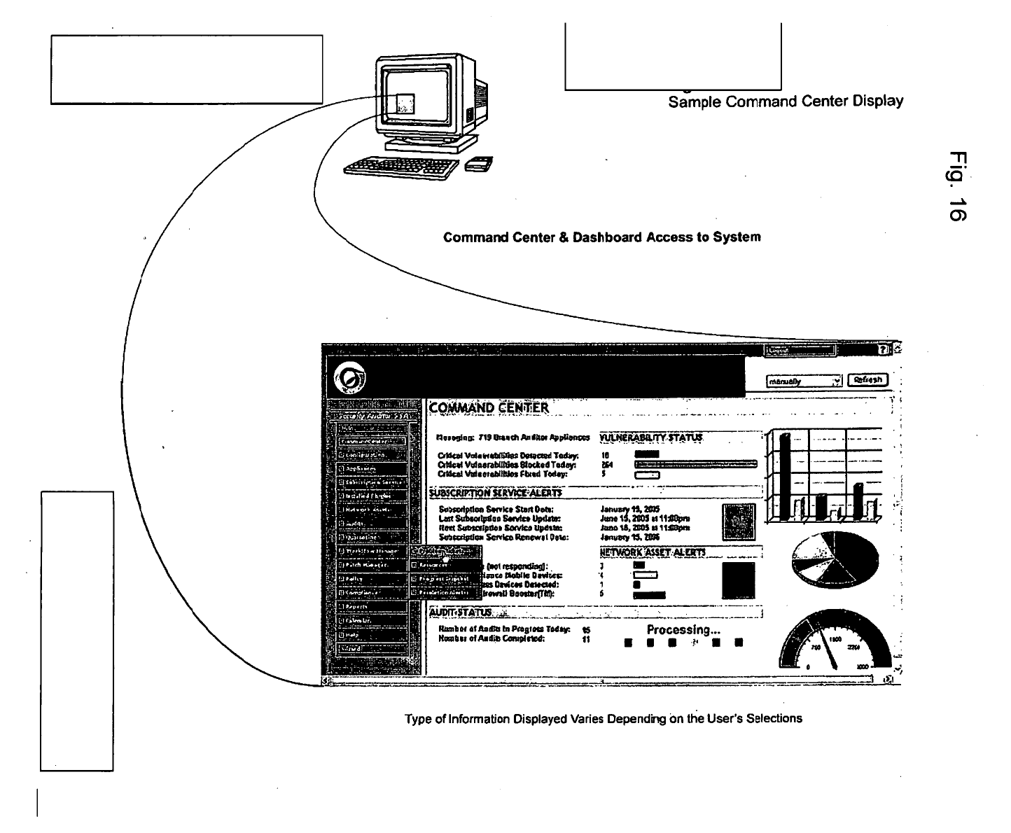

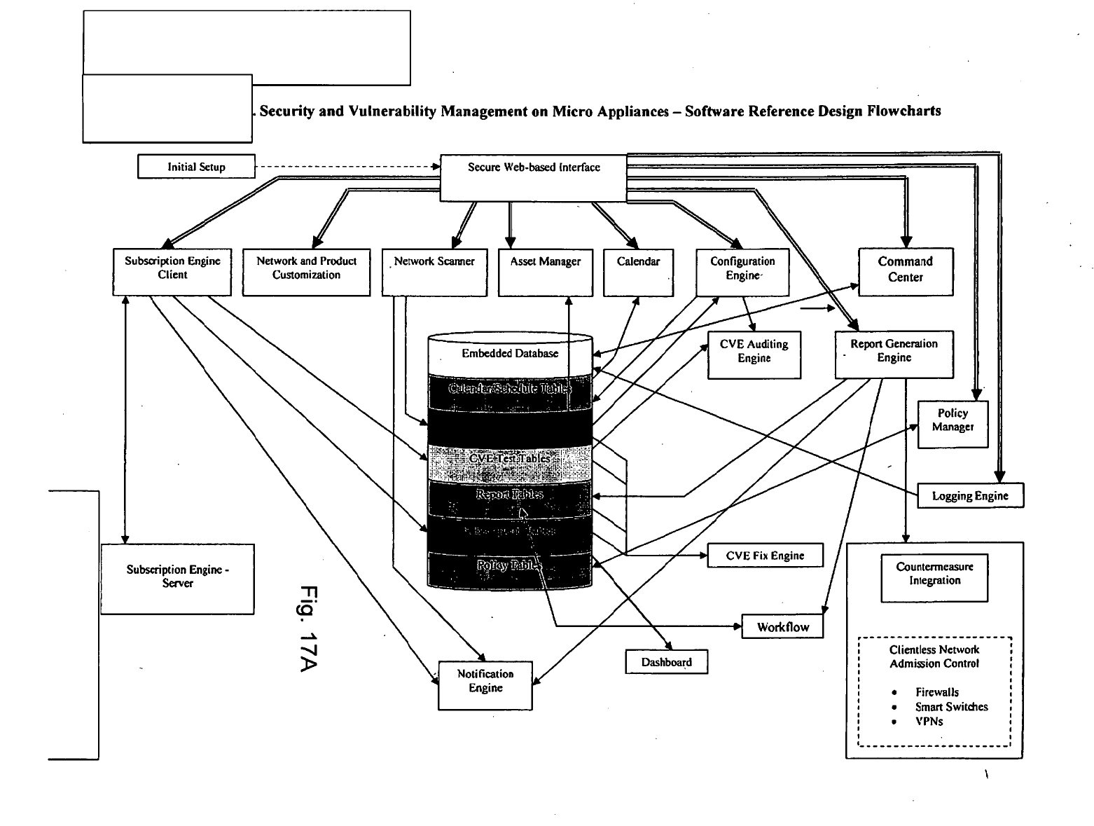

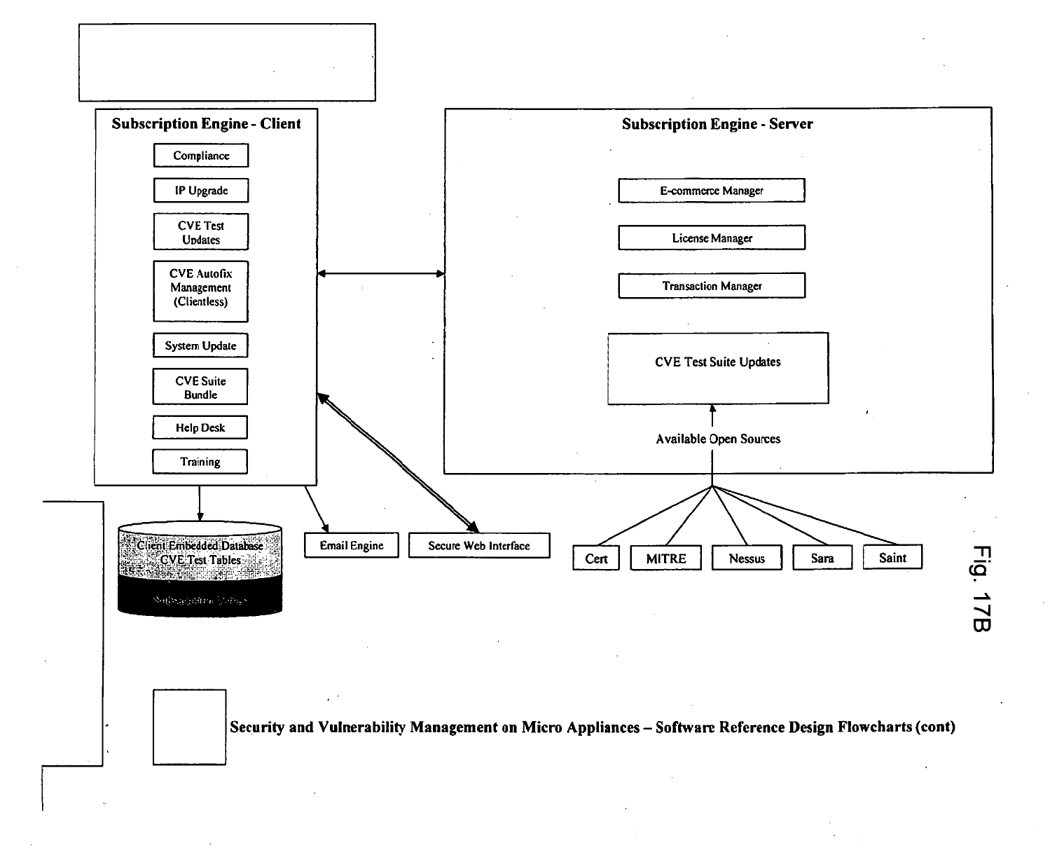

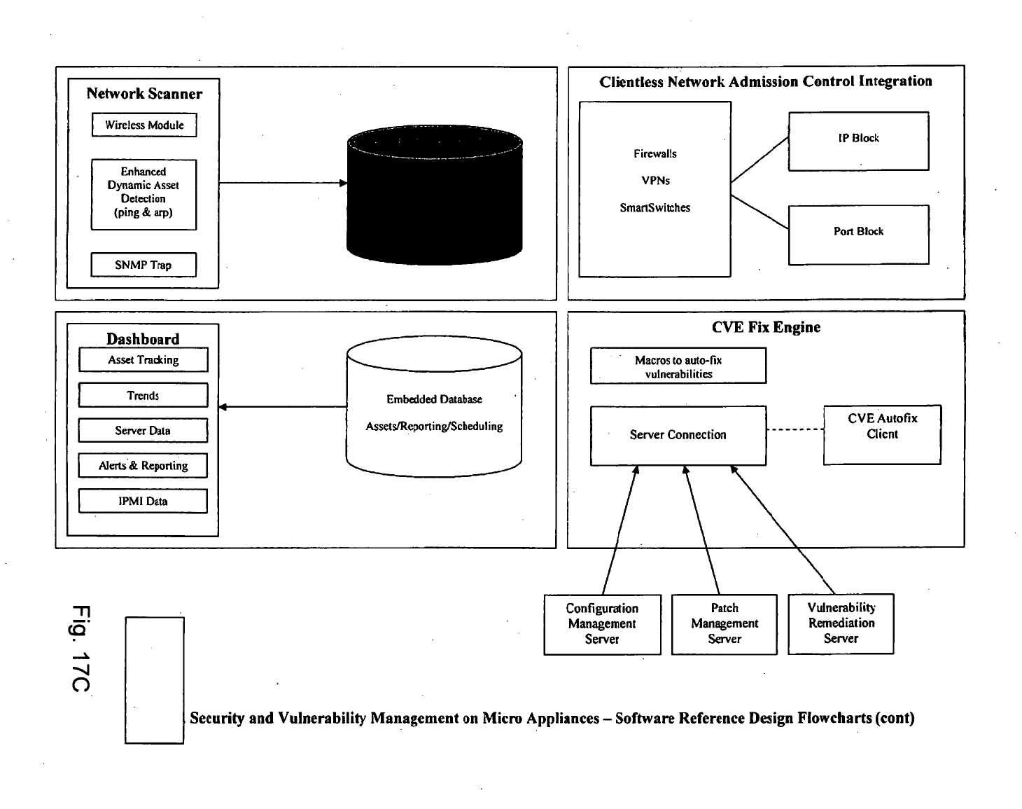

FIGS. 10-17 illustrate security and vulnerability management on micro appliances, which comprises a dashboard or graphical user interface (GUI), a security access control (AUTH) and secure communications sub-system (SEC-COMM), network and asset discovery and mapping system (NAADAMS), an asset management engine (ÂME), vulnerability assessment engine (CVE-DISCOVERY), vulnerability remediation and workflow engine (CVEREMEDY), a reporting system (REPORTS), a subscription, updates and licensing system (SULS), a countermeasure communications system (COUNTERMEASURE-COMM), a logging system (LOGS), a database integration engine (DBIE), a database correlation and warehousing engine (DCAWE), a scheduling and configuration engine (SCHEDCONFIG), a wireless and mobile devices/asset detection and management engine (WIRELESS-MOBILE), a notification engine (NOTIFY), a regulatory compliance reviewing and reporting system (REG-COMPLY), clientless network admission control (CLIENTLESS NAC) integration with all major firewalls and smartswitches to dynamically reconfigure the firewall and smartswitch rules and access tables to quarantine problems (CVEs) at the network ports, whether physical or based on the Internet standard (TCP/IP) for ports, or similar protocol based software ports, where these problems reside. The Database Correlation and Warehousing Engine integrates with the clientless network admission control system. The graphical user interface that displays reports and real time analysis from data gathered by multiple Security and Vulnerability Management Micro Appliances.

Dashboard or graphical user interface: A secure graphical user interface which provides an interface for the user to configure the product for their company and network environment, manage the assets of their network, create configurations to audit the assets in their network, access and view reports on the vulnerabilities of their networks, have an interface for the subscription service including upsells to the products, downloads of compliance documents. This will also provide an interface to a dashboard where the user can track the changes in the network, see logging information of the activity on the appliance and more generally any compiled information which can be obtained from the knowledge gathered about the assets in the network. There are various Structural and Functional variations to the implementation of the GUI. One model is to create a tiny web server which generates web pages either securely, through Secure Sockets Layer (TSL, SSL, or HTTPS) or non-securely (HTTP) over the Internet or local area network (LAN). Each screen is dynamically generated as a result of web-based (HTML) input from the end users. Another variation is the creation of a client-based application, developed using standard Windows or similar GUI client tools that can connect either securely or insecurely over a network to a server-side interface using a secure communications subsystem. Other methods include the development of a GUI using the JAVA programming language or MYSQL databases with Perl, Python or PHP tied into a small web application server.

Security access control: This is a secure communications sub-system engine which provides a secure method in which an end-user can access the appliance and all the functionality of that appliance as well as providing secure means in which to upload and download files, reports, subscription data and in general any relevant data compiled, generated or related to the functionality of the appliance. The secure communications subsystem engine uses the secure internet protocol of secure sockets layer (SSL) or the secure hypertext transfer protocol to share information between the GUI client and the Micro appliance security and vulnerability management server.

Secure communications sub-system: This is a network and asset discovery mapping system that will determine the assets that are on the network both through an on-demand asset detection engine as well as a dynamic detection engine. It will gather data about these assets including the system information, application information, user information, location and other relevant information. Network and asset discovery mapping system uses various methodologies to poll devices throughout the local area network (LAN) to determine what systems are available and online. Each network asset will typically respond with an IP Address and through standard packet sniffing methodologies, the solution will be able to determine the MAC address and Operating System as well.

Asset management engine: This engine is an asset management engine which works closely with the network and asset discovery mapping system (NAADAMS). This engine will track the changes in the assets on the network, provide an overview of the network as well as detailed information to the system admin. It will compile statistics for these assets providing information to the user to better manage those assets as well as improved methods of complying with government regulations. This system communicates with the internal NAADAMS to manage a list of all assets within the network including IP Address, MAC address and Operating System. It contains ADD, DELETE, EDIT and RENAME functionality for each discovered network asset.

Common vulnerabilities and exposure discovery engine: This is a common vulnerabilities and discovery engine which audits the devices on a network to determine the vulnerabilities it has which hackers could exploit. This engine will have several levels of intrusiveness which will affect how rapidly it detects the vulnerabilities as well as how intrusively that detection is. It will also retain a database of past audits allowing for differential audits comparing previous audits with older audits as well as incremental audits which test for only the latest known vulnerabilities. Common vulnerabilities and discovery engine uses the similar approach to CVE discovery as the Open Source Nessus.org project and the Open Source SARA project. Traditional network security scanners tend to focus on the services listening on the network—and only on these. Now that viruses and worms are propagating thanks to flaws in mail clients or web browsers, this conception of security is getting outdated. The CVE Discovery engine uses a remote security scanning methodology similar to these two programs, NESSUS and SARA, with the ability to detect the remote flaws of the hosts on the network and their local flaws and missing patches as well—whether they are running Windows, Solaris, Mac OS X or a Unix-like system.

Common vulnerabilities and exposure remediation engine: This engine is a common vulnerabilities and remediation engine. This engine will allow for both automated and on-demand methods of remediating security vulnerabilities that have been found on assets in the network. This will include scripts and macros and other similar methods used to remove vulnerabilities from the network. Common vulnerabilities and remediation engine variations include functionality to allow customers to select which IP Addresses need to be repaired by the removal of the Common Vulnerability and Exposure (CVE) which has been discovered. The Workflow component of the CVE-REMEDY system enables end users to accept CVE repairs and if a client or agent exists on the network asset that contains a CVE, a connection is made to the client to initiate a patch or system reconfiguration and resolve the CVE.

Reporting system: This is a reporting system engine which generates reports in various formats providing information to the user about vulnerabilities on their system, methods of remediating these vulnerabilities, assets on their network, updates to their system, compliance with regulations as well as any pertinent information about the state of their network. Reporting system engine variations include centralized reporting, easily customizable reports for flexible reporting, automated trending and differential reports for gap analysis, remediation reporting for the workflow engine including ticket trending and tickets by group, user, and vulnerability as well as web-based reporting immediately available to authorized users. Reports may be output in PDF, XML, CSV, XLS, HTML, and other industry standard report formats.

Subscription, updates and licensing system: This is a subscription, updates and licensing system which provides the end-user a method of obtaining the latest vulnerability tests, code updates and in general any subscription updates they have paid for. This system provides a licensing system so that these updates can be properly managed by the provider. This system will be composed of a server engine on a publicly hosted site and a client-engine on each appliance. The server engine will contain a database, a license manager and all vulnerability tests, code updates and subscription data and files pertinent to the subscription service. The client engine will contain a secure mechanism to request updates from the server as well as a mechanism to change the license available to the end-user. Subscription, updates and licensing system variations include built-in functionality to connect to the subscription server and obtain various pieces of information including subscription start date confirmation, subscription end date confirmation, options to expand current subscription and an e-commerce component to enable instant one-click purchasing of subscription updates. The SULS also allows end customers to obtain soft updates for any functionality that has been improved or changed in the system.

Countermeasure communications system: The Countermeasure Communications engine shares dynamically detected information about current and new network assets for the dynamic reconfiguration of firewalls, virtual private networks (VPNs) and SmartSwitches to quarantine CVEs (problems) detected in any and all trusted network assets at the port level, blocking problems at ports, not people and productivity. In the event a network asset is untrusted, such as a rogue laptop or wireless router, it is quarantined at all possible points of entry and exit including but not limited to the firewall, VPN and SmartSwitch. This system will also send an alert through E-mail and SMS paging to an IT Manager or designated end user to let them know that the system detected a rogue or high risk asset and took action, automatically.

Logging system: A logging system which provides the end-user with data of the activities on the appliance. This includes system, user and event logs. The system logs comprise, but are not limited to, issues related to the hardware, software, services and network, and any changes that may occur to these components, whether through user interaction, automated functionality, system failure or any other means. The user logs comprise, but are not limited to, activities instigated by an end-user. This includes any access to the product and subsequent activity performed by that user. User logging will also include tracking of concurrent users accessing the product, when any access occurred, failed login attempts and any unauthorized activity. Event logging includes any operating system related issues, reboots, shutdowns: Also update activities including the vulnerability test updates, code updates, subscription service updates, license upgrades and related activities.

Database integration engine with workflow: This engine is based on a Relational Database engine which consists of a workflow control system, ticketing control system, tracking and verification system which integrate reporting, asset, workflow and logging databases. It uses data warehouse methodologies to correlate data from numerous sources via a command center. The workflow control system sets up, distributes and manages the overall workflow process. The ticketing control system assigns workflow activities to customer defined resources, assigns priorities and escalates priorities as needed. The tracking and verification system keeps a status of the workflow process, provides reports and alerts and finalizes completed workflow activities. The database integration leverages drivers with ODBC (Open DataBase Connectivity), JDBC (Java Database Connectivity), UDBC (Universal Database Connection) and OLE DB & CROSS to fully integrate the underlying databases with the applications running on the system.

Scheduling and configuration engine: The scheduling and configuration engine controls any process on the product which pertains to scheduled activities or the configuration of the system, audits or any processes running on the product. This includes but is not limited to the auto-update process for obtaining vulnerability tests, subscription updates or code updates. It also includes auditing and reporting processes, workflow, network discovery, dashboard, command center, and logging processes.

Wireless and mobile devices/asset detection and management engine: The wireless and mobile devices/asset detection and management engine includes a wireless access point and mobile device discovery system which links into the notification engine, countermeasure engine and database engine. This discovery engine detects systems through various means including network scanners such as Nmap, Nessus, SARA, DHCP broadcasts, traffic analyzers and SNMP traps and other similar tools. The engine sends alerts through the alerting engine relating data about the existence and state of wireless and mobile devices discovered. This engine also interacts with the countermeasure engine, providing a means to quarantine and/or control the flow of traffic to and from the wireless and mobile devices. This includes traffic control via firewalls, smartswitches, VPNs and similar technology. This engine also interacts with the database engine to store and track all data related to wireless and mobile assets.

Notification engine: The notification engine interacts with all components of the system to provide notifications, alerts and status based on the activity of the product. This includes but is not limited to data from the update engine (vulnerability tests updates, code updates, subscription updates, etc.), reporting engine, logging engine, workflow engine, network discovery, asset engines and wireless and mobile devices/asset detection and management engine. Notification is provided through email, SMS messages, cell phone alerts, pager messages and similar such communication media.

Regulatory compliance reviewing and reporting system: The regulatory compliance reviewing and reporting system is an engine which combines the corporate security policy, government regulations, business security programs, vulnerability assessment and reporting features of the product into an integrated system for assessing and reporting the status of assets as they pertain to regulatory compliance. The engine ties regulations, company policies and security programs to assets and to vulnerability tests in order to ascertain the level of compliance with these regulations, policies and programs. This engine leverages the data obtained through the vulnerability assessment engine to assess the level of compliance. Automated actions ensue from these results in conjunction with the countermeasure engine to ensure the security of assets as well as compliance with policies and regulations. The engine provides related data to the alerting engine. The engine also provides data to the reporting and database correlation and warehouse engines.

Database Correlation and Warehousing Engine: This engine gathers data from processes and results throughout the product as well as from internal/external resources, including but not limited to the Update Servers, Countermeasure appliances, Data feeds, other devices of the same nature as this patent describes and any related third party sources. The engine uses data warehouse methodologies to store this data. The engine also provides a means of querying the database and warehouse information either through automated methods or through on-demand user interfaces.

Clientless network admission control system: This engine provides a means to control the access of network devices onto networks. The engine does not require any software to be installed on any of the target devices. The engine uses a combination of the network discovery engine, vulnerability assessment engine, database correlation engine, wireless and mobile device detection engine to determine when a network device has permission to access the network. This determination is also based upon information obtained from the regulatory compliance reviewing and reporting system and policies. This engine interacts with the countermeasure communications system to control the access of each network appliance. The engine is designed to work in a multi-branch solution and provide extensible authorization. It securely connects to firewalls, smartswitches, and VPNs to reconfigure their rules and access control lists around CVE related problems and ports, not people and productivity.

Graphical user interface that displays reports and real time analysis from data gathered by multiple Security and Vulnerability Management Micro Appliances: This engine provides a means to gather data in a multi-branch environment from numerous Security and Vulnerability Management Micro Appliances; correlate this data; and display data, trends, status and real time analysis of this data. It provides a means to query from an updated data warehouse to provide user defined reports and information.

It also provides a means to remotely manage the Security and Vulnerability Management Micro Appliances. This engine provides a network summary including but not limited to missing network devices, vulnerability counts, interactions with countermeasures and status of the vulnerability tests, and code and subscription updates across the multi-branch environment.

The graphical user interface (GUI) provides connections to all components of the appliance. It is the means in which the end-user has access to control the functionality of the appliance. The security access control (AUTH) is connected to the graphical user interface (GUI) to allow security controls over how an end-user may access the appliance. It also interacts with the reporting system (REPORTS) to provide encryption capabilities for access to reports and sensitive data. It is also connection to the database engine (DBIE) so that all access to the appliance can be tracked and monitored. The secure communications sub-system (SEC-COMM) is connected to the subscription service (SULS) providing a secure means in which vulnerability tests can be added to the appliance as well as updating the license of the end-user and providing any upsell or functional enhancements to the appliance. It is also connected to the database engine (DBIE) so that all secure transactions through this component can be tracked and monitored. The network and asset discovery and mapping engine (NAADAMS) is interconnected with the asset management engine (AME), providing the data necessary for this component as well as with the database engine. Other components are CVE-DISCOVERY, a common vulnerabilities and discovery engine; CVE-REMEDY, a common vulnerabilities and remediation engine; REPORTS, a reporting system; SULS, a subscription, updates and licensing system; COUNTER-MEASURE-COMM, a countermeasures communication system; LOGS), a logging system; DBIE, a database integration engine; SCHED-CONFIG, a scheduling and configuration engine; WIRELESS-MOBILE, a wireless and mobile devices/asset detection and management engine; NOT WY, a notification engine, and REG-COMPLY, a regulatory compliance reviewing and reporting system.

The system is designed around a number of engines which work together to provide state of the art vulnerability assessment, reporting, management, and remediation capabilities on a micro-platform. Other than a one time setup interface over a serial connection to a hyperterminal interface, the appliance is a headless device where the end-user interface is through a secure web interface. Data is stored in both a flat-file format and a secure relational database server. The vulnerability assessment component is based on a SmartScan engine which scans network assets for flaws and weaknesses in the systems. A network discovery engine provides a means to determine the assets on a network both through on-demand means initiated by an end-user and through dynamic detection as assets appear on the network. Vulnerability and asset data is stored in the appliance and reporting results are auto-generated and provided on demand through a query interface. Vulnerable systems are quarantined from the network through a countermeasure engine which interacts with firewalls, smartswitches and other similar devices. All vulnerability data is passed to a workflow engine which allows the end-user to assign remediation needs to resources, track the status and escalate the status as needed. A notification engine is tied in to all processes providing the end-user instant information on the status of the network and the components in the appliance. A dashboard and command center allows the user an easy interface to manage and review the status of the entire network and assets whether they are local or in remote locations. A logging engine collects all pertinent data about the system, user access, functionality and processes on the appliance.

As to a further discussion of the manner of usage and operation of the present invention, the same should be apparent from the above description. Accordingly, no further discussion relating to the manner of usage and operation will be provided.

With respect to the above description then, it is to be realized that the optimum dimensional relationships for the parts of the invention, to include variations in size, materials, shape, form, function and manner of operation, assembly and use, are deemed readily apparent and obvious to one skilled in the art, and all equivalent relationships to those illustrated in the drawings and described in the specification are intended to be encompassed by this disclosure. It will also be understood that the embodiments of a security micro-appliance, and a security system using one or more micro-appliances, as described above, is an example only, and does not limit the scope of the inventive concepts disclosed herein.

In other embodiments, the security system described herein may employ RSS or any other XML-based syntax(es) for communicating status and other information from security appliances and/or publishing security updates or configuration instructions to security appliances. RSS is a Web content syndication format. Its name is an acronym for Really Simple Syndication. RSS is a dialect of XML. All RSS files must conform to the XML 1.0 specification, as published on the World Wide Web Consortium (W3C) website. RSS feeds include Channels and Elements.

Part of the convergence of exploit, threat and vulnerability analysis happening at MITRE that will help accelerate the release of a preferred embodiment of RSS-based Security appliances and services, is MITRE's OVAL standard, funded by the U.S. Department of Homeland Security (DHS).

OVAL is the Open Vulnerability Assessment Language. It is funded by the U.S. Department of Homeland Security (DHS) and in summary the XML, machine readable format for the Common Vulnerabilities and Exposures (CVE®) standard. OVAL is an international, information security community baseline standard for how to check for the presence of vulnerabilities and configuration issues on computer systems. OVAL standardizes the three main steps of the process with an OVAL System Characteristics Schema for collecting configuration data from systems for testing; OVAL Definitions to test for the presence of specific vulnerabilities, configuration issues, and/or patches; and an OVAL Results Schema for reporting the results from the evaluated systems.

The tests are standardized, machine-readable XML Vulnerability Definitions, Compliance Definitions, and Patch Definitions. OVAL's schemas and definitions are all free to download, use, reference, and implement. An “OVAL-compatible” tool, service, Web site, database, or advisory/alert uses the Open Vulnerability and Assessment Language (OVAL), as appropriate, for communicating details of vulnerabilities, patches, security configuration settings, or machine state. An “OVAL-ID compatible” tool, Web site, database, archive, or security advisory includes OVAL-ids as part of the information it conveys about a security issue, and provides for searching by OVAL ID with potential linkage back to the source definition of the OVAL-ID.

OVAL itself is an international cyber security community effort to standardize the identification of vulnerability, configuration, or patch issues on computers by developing standardized, machine-readable vulnerability, patch, and configuration definitions. Each of the different kinds of definitions is referred to as a “class” of definitions. The structure and vocabulary of an OVAL definition is controlled by the Official OVAL Definition Schema, which was developed by the OVAL Community and approved by the OVAL Board. The OVAL Definition Schema is composed of a Core Schema that defines the general structure of an OVAL definition, and Component Schemas that extend the OVAL Definition Schema to particular operating systems or major application.

In addition to the OVAL Definition Schema, the OVAL community has developed two additional schemas to assist in the process of analyzing OVAL definitions. The Official OVAL System Characteristics Schema defines a standard format for expressing the file system information and configuration parameters gathered from a specific computer. The purpose of this schema is to provide a tool with a snapshot of a system's configuration at a particular point in time. The Official OVAL Results Schema defines a standard format for expressing the outcome of performing an analysis using OVAL definitions. The purpose of this schema is to allow capabilities to exchange the OVAL analysis results in a standardized format.

When talking about OVAL compatibility it is necessary to consider each of these schemas and how they will be used. For each schema there is a notion of “producers” and “consumers.” Typically, a Feed Provider, today, provides news and related information as an XML Feed, through various Aggregators to end Users (Consumers).

Although the feeds are machine readable as XML data sets, very few tools are available today to take advantage of this real-time feed. Most tools are used for the rendering of RSS feed information into a human-readable version such as an HTML news page or an e-mail update.

Feed consumers—there will be two feed consumers—people and INFOSEC countermeasures. The people—typically, but not limited to the CFO, CIO, CSO and IT Managers, who will use the information provided to augment their security posture in real-time, while the countermeasures will be able to use the feed to dynamically reconfigure themselves based on Global and local security threats as well as the internal vulnerabilities or weaknesses found in the internal assets through a real-time CVE® differential analysis performed by the preferred embodiment system.

Regulations such as Sarbanes-Oxley, GLBA, HIPAA, and others are only the beginning. The possibility of an upcoming cybersecurity audit mandated by the SEC looms large. The need for proactive and regular external IT security audits as well as internal controls has led to the need of real-time feeds—an RSS feed-based INFOSEC solution. As a result, networks will be more secure, experience more uptime and outdated INFOSEC countermeasure equipment—Firewalls/VPNs, IDS, IPS, Antivirus, etc. will be able to perform in an optimized fashion, taking a more holistic view of network security, in real-time, based upon the new and critical RSS feed provided by the preferred embodiment.

This unique utility may be deployed through software-only as well as software on turnkey industry standard rack mount as well as smaller micro appliances construction wherein the same can be utilized for helping Information Technology (IT) Managers better see and remove the problems or flaws, also known as common vulnerabilities and exposures (CVEs), in their managed network equipment, computers, servers, hardware and related systems, which are used on a daily basis to store, edit, change, manage, control, backup and delete network-based assets. My invention includes RSS feed-based updates, alerts and vulnerability tests as well as data replication, correlation and warehousing for reporting, trending, real-time vulnerability and gap analysis among multiple micro appliance deployments. This will also enable larger geographically distributed enterprises with many branches to have a “dashboard” view of their threat and risk profiles throughout their Networks.

In these respects, the vulnerability management and intrusion prevention software and appliances according to the present invention substantially departs from the conventional concepts and designs of the prior art, and in so doing provides an apparatus primarily developed for the purpose of helping Information Technology (IT) Managers better see and remove the problems or flaws, also known as common vulnerabilities and exposures (CVEs), in their managed network equipment, computers, servers, hardware and related systems, which are used on a daily basis to store, edit, change, manage, control, backup and delete network-based assets. They will be better prepared to defend against zero-day exploits and attacks, increasing network uptime and improving IT compliance with various government regulatory requirements including but not limited to Sarbanes-Oxley (SOX), GLBA, HIPAA, E-SIGN, EO13231, CFR21 FDA 11, Visa PCI and MasterCard SDP compliance and other regulations.

The systems disclosed herein may include RSS Feed-based coordination, aggregation and delivery of global threat and internal asset vulnerability information from MITRE, US-CERT, the SANS Institute and the National Institute of Standards and Technology (NIST), among others, data replication, correlation and warehousing for reporting, trending, real-time vulnerability and gap analysis using Extensible Markup Language (XML) for standardization, communication and correlation among multiple deployments. This may also enable larger geographically distributed enterprises with many branches to have a “dashboard” view of their threat and risk profiles throughout their Networks. Each Extranet is yet another backdoor to any corporate network that needs to be managed remotely. Next generation vulnerability management and Intrusion Prevention software and appliances using RSS Feeds will be able to close such backdoors and defend against zero-day exploits.

End users will ultimately be able to automatically, proactively defend their networks and quarantine vulnerabilities without having to install a client on every device or spend thousands of dollars on complex systems and thereby protecting the Confidentiality, Availability and Integrity of their Networks and related confidential communications.

In general, an RSS-based security system may include an RSS Feed-based system with a dashboard or graphical user interface (GUI), a security access control (AUTH) and secure communications sub-system (SEC-COMM), Transport Control Protocol/Internet Protocol (TCP/IP), User Datagram Protocol (UDP) and Session Initiation Protocol (SIP) network and asset discover and mapping system (T-U-S-NAADAMS), a asset management engine (AME), vulnerability assessment engine (CVEDISCOVERY), vulnerability remediation and workflow engine (CVE-REMEDY), a reporting system (REPORTS), a subscription, updates and licensing system (SULS), a ready countermeasure communications system (COUNTERMEASURE-COMM), a logging system (LOGS), a database integration engine (DBIE), a database correlation and warehousing engine (DCAWE), a scheduling and configuration engine (SCHED-CONFIG), a device, wireless-enabled and mobile devices/asset detection and management engine (WIRELESS-MOBILE), an RSS-Feed based notification engine (NOTIFY) which uses XML, a regulatory compliance reviewing and reporting system (REG-COMPLY), using RSS Feeds in real-time to drive clientless network admission control (CLIENTLESS NAC) integration with all major INFOSEC Countermeasures (including but not limited to firewalls, VPNs, ids, ips, patch management, configuration management and smartswitches) to dynamically reconfigure the firewall and smartswitch rules and access tables to quarantine problems (CVEs) at the network ports, whether physical or based on the internet standard (TCP/IP), UDP, SIP or otherwise for ports, or similar protocol based software ports, where these problems reside. Of particular uniqueness is an automated self healing capability, that is, if a CVE can be automatically remedied, it will be done through the system by way of integration with traditional patch management and/or configuration management systems through the CVE-REMEDY system.

The system may provide Vulnerability Management and Intrusion Prevention systems that uses RSS feeds in real-time.

The system may provide a Vulnerability Management and Intrusion Prevention systems that uses Really Simple Syndication (RSS) Feeds for helping Information Technology (IT) Managers better see and remove the problems or flaws, also known as common vulnerabilities and exposures (CVEs), in their managed network equipment, computers, servers, hardware and related systems, which are used on a daily basis to store, edit, change, manage, control, backup and delete network-based assets and communications. The system may include data replication, correlation and warehousing for reporting, trending, real-time vulnerability, malicious traffic and gap analysis among multiple software and/or blade and/or rack mount and/or micro appliance deployments. This will also enable larger geographically distributed enterprises with many branches to have a “dashboard” view of their threat and risk profiles throughout their Networks.

The system may provide a Vulnerability Management and Intrusion Prevention systems that uses RSS Feeds in real-time to include not only software or combination of software running on traditional rack mount appliances but also very compact computer Micro Appliances and can fit in the palm of human hands, which finds most or all of the common vulnerabilities and exposures (CVEs) on network-based assets such as computers, servers and related computer and network equipment and share this data with numerous INFOSEC Countermeasures including but not limited to intelligent ready firewalls and smartswitches to dynamically reconfigure their rules tables and access points including the physical ports of smartswitches providing time to repair vulnerabilities before they are exploited by hackers, viruses or worms.

The system may provide a Vulnerability Management and Intrusion Prevention systems that uses RSS Feeds in real-time to help resolve through partial or full automated remediation most or all of the common vulnerabilities and exposures (CVEs) found on network-based assets such as Internet enabled computers, servers and related computer and network equipment and share this data with the switching systems, serial connectivity devices, extension and remote access products, technologies, software and hardware. The switching and connectivity solutions may provide IT (information technology) managers with access and control of multiple servers and network data centers from any location. Analog, digital and serial switching solutions, as well as extension and remote access products, technologies and software, may cooperate in managing multiple servers and serially controlled devices from a single local or remote console consisting of an administration interface.

The system may provide a Vulnerability Management and Intrusion Prevention systems that uses RSS Feeds in real-time to enable the web client software (ADMINISTRATIVE CONSOLE) of the Vulnerability Management and Intrusion Prevention Systems to display whether in delayed or real-time methodologies, detection of rogue enabled wired and wireless devices, laptops, mobile equipment and the like, the critical related CVE information discovered on the network through automated scanning and auditing means.

The system may provide a Vulnerability Management and Intrusion Prevention systems that uses RSS Feeds in real-time that enable the web client software (ADMINISTRATIVE CONSOLE) of the Vulnerability Management and Intrusion Prevention Systems to manage and display more detailed asset information such as ownership, serial number, user name, make, model, manufacturer, emergency contact, purchase or lease price and terms as well as any other relevant information that can be attributed to the asset (such as IP Address, SIP related information, MAC address, operating system, hardware specifications, software specifications, physical location, etc.). This also includes the usage of RSS readers and RSS Mobile enabled devices for remote dashboard and administrative operations.

The system may provide a Vulnerability Management and Intrusion Prevention systems that that uses RSS Feeds in real-time to enable the web client software (ADMINISTRATIVE CONSOLE) of the Vulnerability Management and Intrusion Prevention Systems to connect to a subscription service for access to IT manager related add-ons or plug-ins that will help the IT manager do a better job at managing and protecting said assets in relation to their INFOSEC countermeasures in use, proof of best practices for ISO 17799 or similar security and compliance models as well as any other relevant and useful upgrades and additions to the invention.

The system may provide a Vulnerability Management and Intrusion Prevention systems that uses RSS Feeds in real-time to share all necessary Vulnerability Management and Intrusion Prevention Systems functionality and information with both non-enabled and ready firewalls, virtual private networks and smartswitches (COUNTERMEASURES) to enable clientless quarantine of network security problems, blocking ports and problems not people and productivity, seamless reporting, logging and database related storage, tracking and backing up of security auditing related and vulnerability assessment information.

The system may provide a Vulnerability Management and Intrusion Prevention systems that uses RSS Feeds in real-time to share authentication and related access control information, protocols and communications with the security services (AUTHENTICATION SERVER) enable the client software (ADMINISTRATIVE CONSOLE) of the Vulnerability Management and Intrusion Prevention Systems to create seamless administrative and user access, privileges and controls.

The system may detect and prevent the success of man-in-the-middle and other eavesdropping attacks against networks by detecting the weaknesses, in advance of an attack, of the assets which are susceptible to such attack and to dynamically reconfigure the network and COUNTERMEASURES to provide the IT staff the time necessary to remediate the related CVE which may be exploited for said attack methodology and to provide remediation instructions which may include one-click fixes such as patches or system reconfigurations to harden the asset against successful exploit.

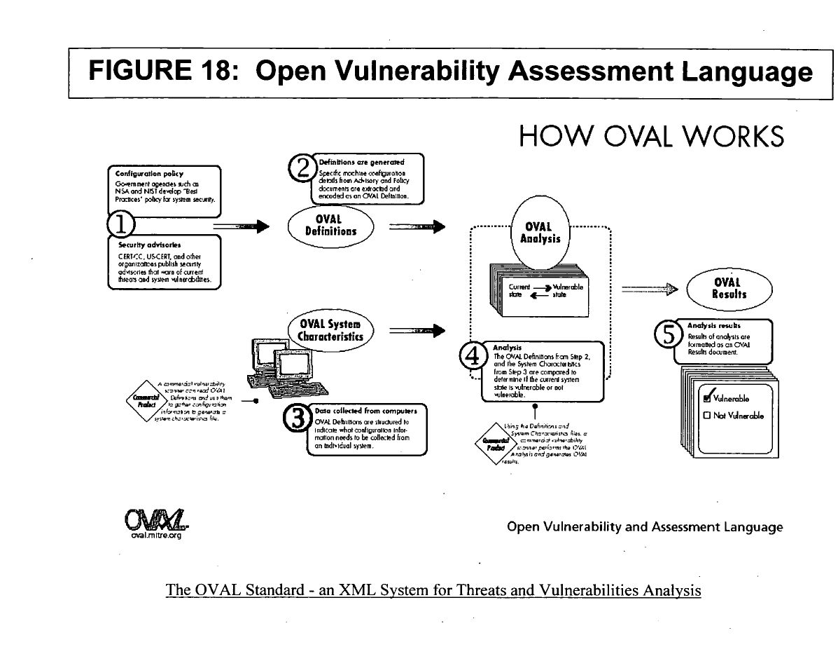

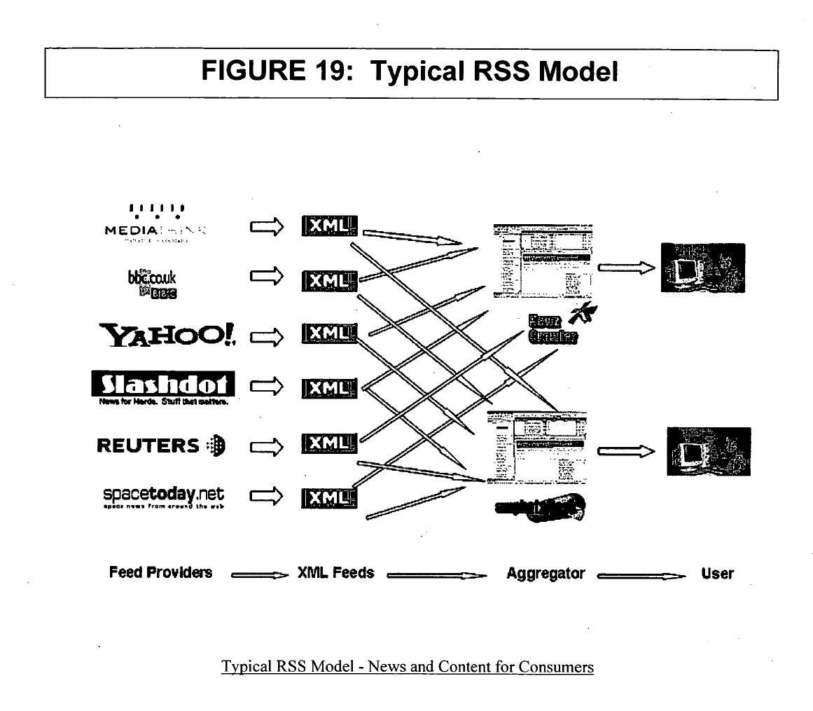

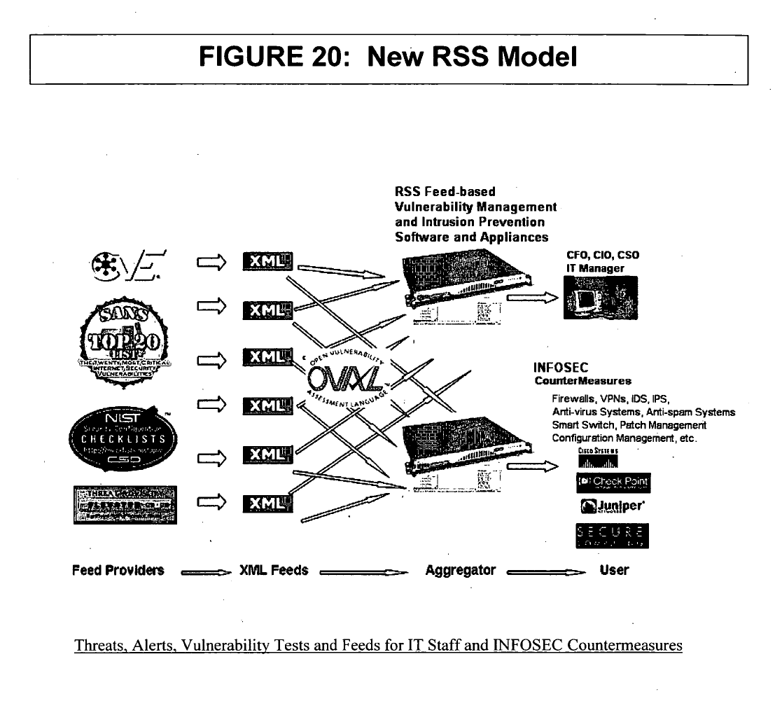

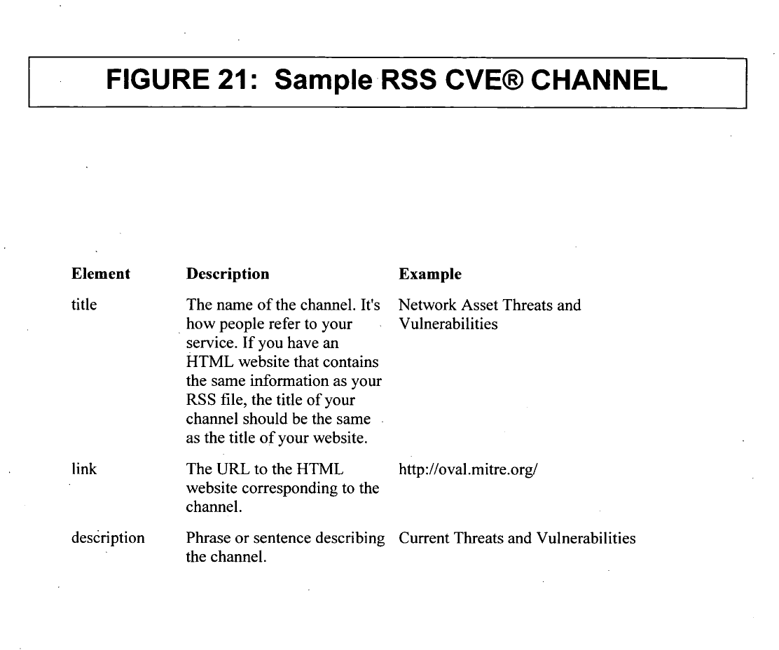

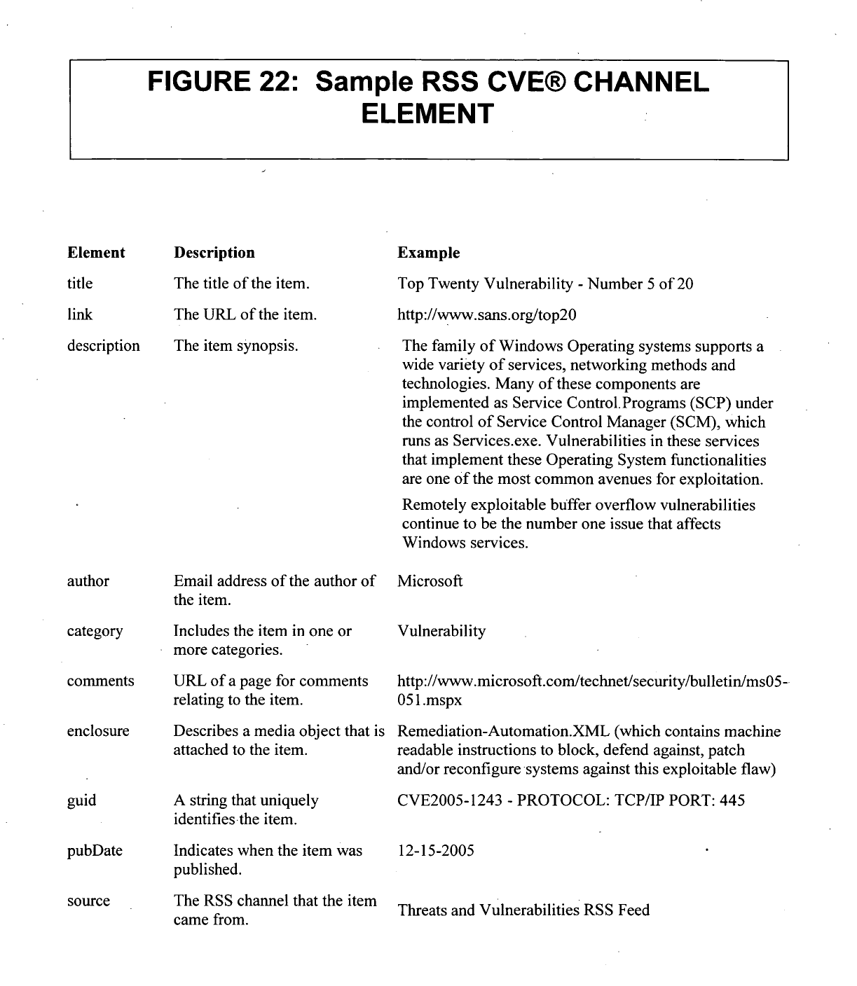

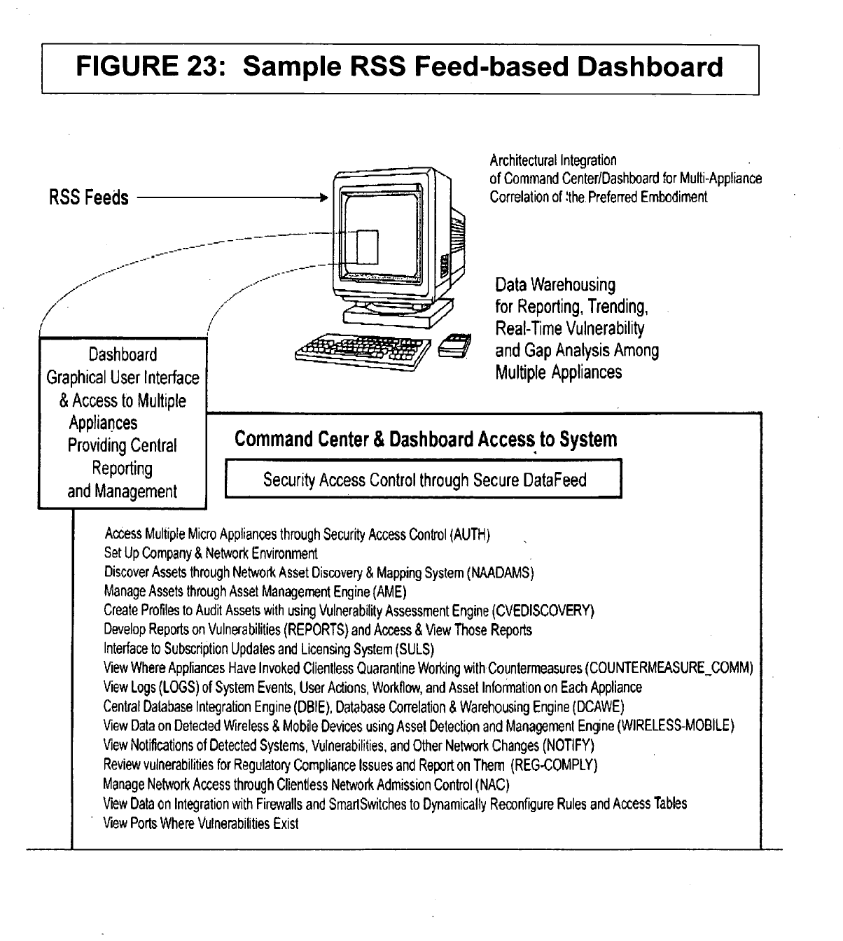

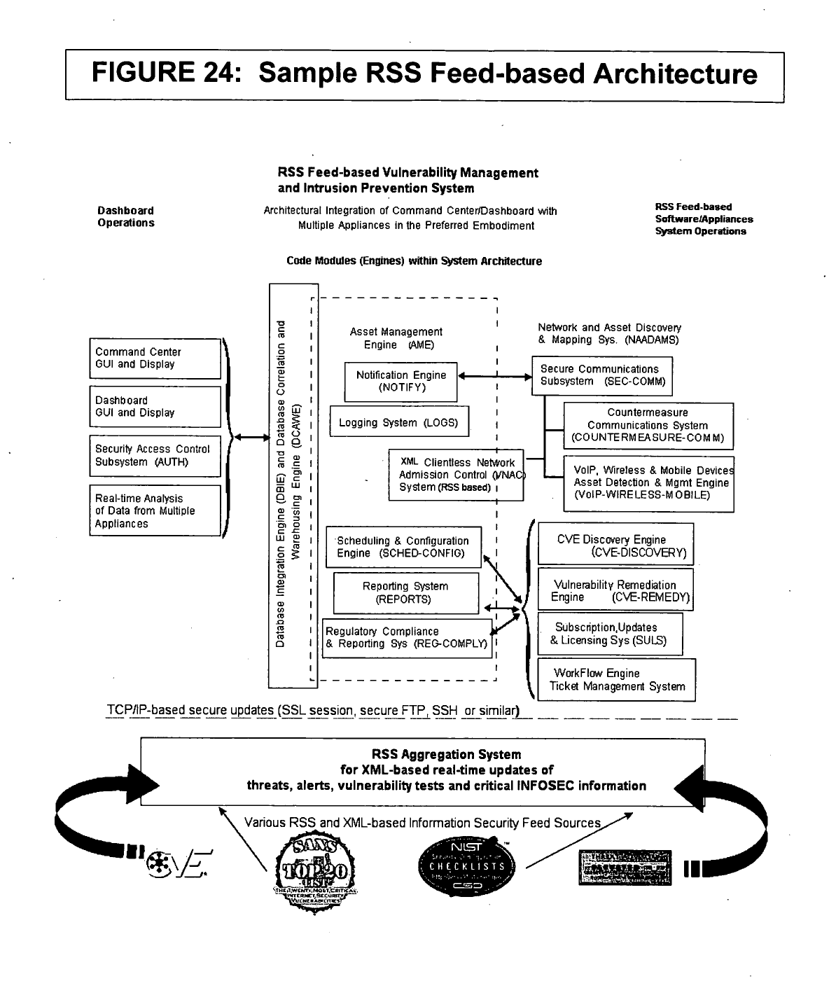

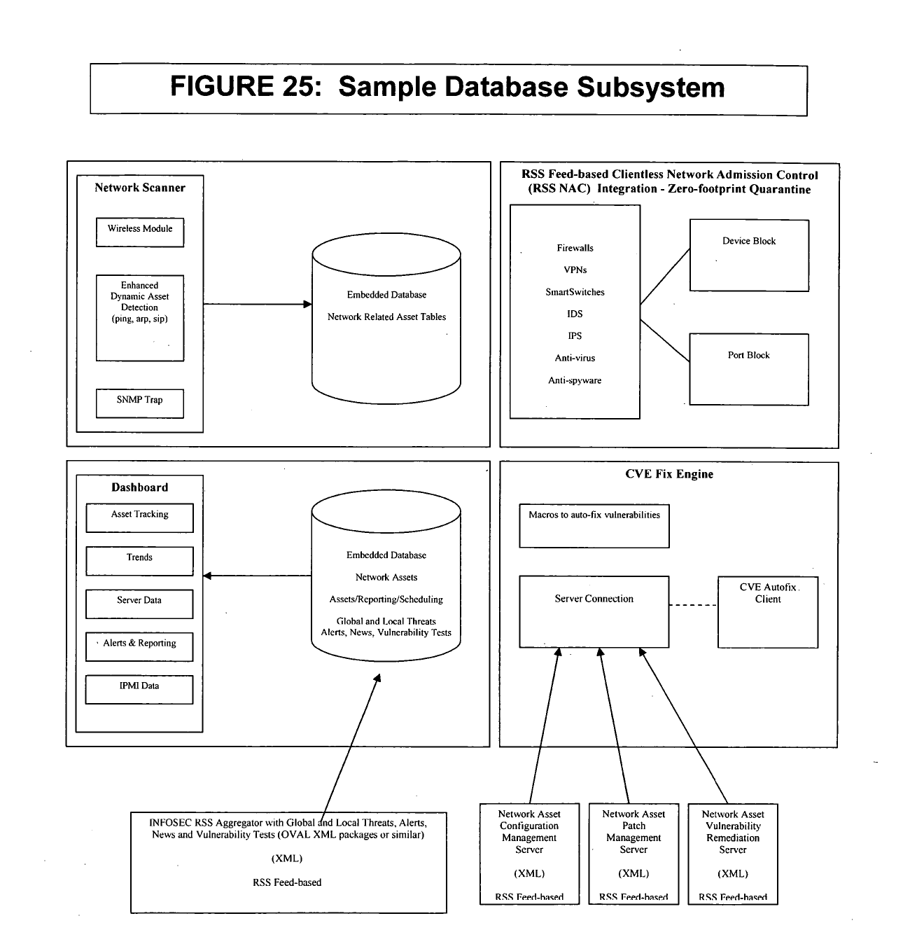

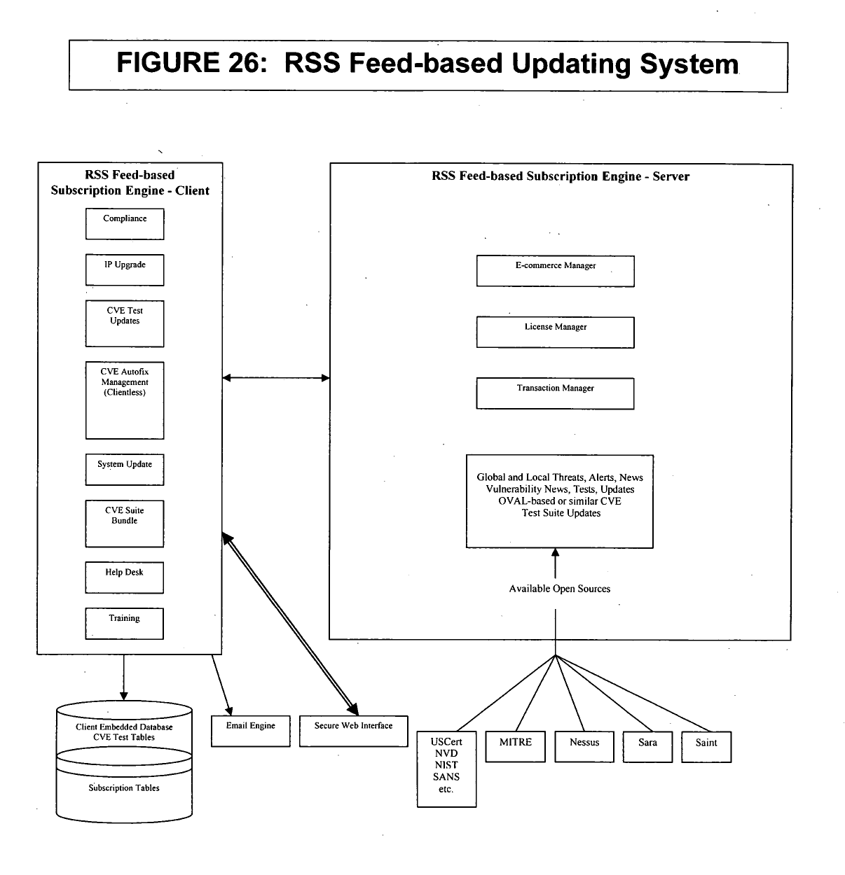

FIGS. 18-26 illustrate RSS Feed-based Vulnerability Management and Intrusion Prevention Systems, which comprises a dashboard or graphical user interface (GUI), a security access control (AUTH) and secure communications sub-system (SEC-COMM), network and asset discover and mapping system (T-U-S-NAADAMS), an asset management engine (AME), vulnerability assessment engine (CVE-DISCOVERY), vulnerability remediation and workflow engine (CVE-REMEDY), a reporting system (REPORTS), a subscription, updates and licensing system (SULS), a countermeasure communications system (COUNTERMEASURE-COMM), a logging system (LOGS), a database integration engine (DBIE), a database correlation and warehousing engine (DCAWE), a scheduling and configuration engine (SCHED-CONFIG), a wireless and mobile devices/asset detection and management engine (WIRELESS-MOBILE), a notification engine (NOTIFY), a regulatory compliance reviewing and reporting system (REG-COMPLY), clientless network admission control (CLIENTLESS NAC) integration with all major firewalls and smartswitches to dynamically reconfigure the ready firewalls and intelligent smartswitches rules and access tables to quarantine problems (CVEs) at the network ports, whether physical or based on the internet standard (TCP/IP), UDP, SIP or other for ports, or similar protocol based software ports, where these problems reside.

GUI—a dashboard or graphical user interface. A secure graphical user interface which provides an interface for the user to configure the product for their company and network environment, manage the assets of their network, create configurations to audit the assets in their network, access and view reports on the vulnerabilities of their networks, have an interface for the subscription service including upsells to the products, downloads of compliance documents, This will also provide an interface to a dashboard where the user can track the changes in the network, see logging information of the activity on the appliance and more generally any compiled information which can be obtained from the knowledge gathered about the assets in the network. There are various Structural and Functional variations to the implementation of the GUI. One model is to create a tiny web server which generates web pages either securely, through Secure Sockets Layer (SSL/HTTPS) or non-securely (HTTP) over the Internet or local area network (LAN). Each screen is dynamically generated as a result of web-based (HTML) input from the end users. Another variation is the creation of a client-based application, developed using standard Windows or similar GUI client tools that can connect either securely or insecurely over a network to a server-side interface using a secure communications sub-system. Other methods include the development of a GUI using the JAVA programming language or MYSQL databases with Perl, Python or PHP tied into a small web application server.

Secure Access Control—this is a secure communications sub-system engine which provides a secure method in which an end-user can access the appliance and all the functionality of that appliance as well as providing secure means in which to upload and download files, reports, subscription data and in general any relevant data compiled, generated or related to the functionality of the appliance. The secure communications sub-system engine uses the secure internet protocol of secure sockets layer (SSL) or the secure hypertext transfer protocol (HTTPS) to share information between the GUI client and the Micro appliance Vulnerability Management and Intrusion Prevention Systems server.

Secure Communications Sub-system—this is a network and asset discovery mapping system that will determine and other assets that are on the network both through an on demand asset detection engine as well as a dynamic detection engine. It will gather data about these assets including the system information, application information, user information, location and other relevant information. Network and asset discovery mapping system uses various methodologies to poll devices throughout the local area network (LAN) to determine what systems are available and online. Each network asset will typically respond with an IP Address and through standard packet sniffing methodologies, the solution will be able to determine the MAC address and Operating System as well.

Asset Management Engine—This engine is an asset management engine which works closely with the network and asset discovery mapping system (T-U-S-NAADAMS). This engine will track the changes in the computer equipment and other related assets on the network, provide an overview of the network as well as detailed information to the system admin. It will compile statistics for these assets providing information to the user to better manage those assets as well as improved methods of complying with government regulations. This system communicates with the internal T-U-S-NAADAMS to manage a list of all assets within the network including IP Address, MAC address and Operating System. It contains ADD, DELETE, EDIT and RENAME functionality for each discovered network asset.

Common Vulnerabilities and Exposure Discovery Engine—this is a common vulnerabilities and discovery engine which audits all of devices on a network to determine the vulnerabilities it has which hackers, viruses or worms could exploit. This engine will have several levels of intrusiveness which will affect how rapidly it detects the vulnerabilities as well as how intrusively that detection is. It will also retain a database of past audits allowing for differential audits comparing previous audits with older audits as well as incremental audits which test for only the latest known vulnerabilities. Common vulnerabilities and discovery engine uses the similar approach to CVE discovery as the Open Source Nessus.org project and the Open Source SARA project. Traditional network security scanners tend to focus on the services listening on the network—and only on these. Now that viruses and worms are propagating thanks to flaws in mail clients or web browsers, this conception of security is getting outdated. The CVE Discovery engine uses a remote security scanning methodology similar to these two programs, NESSUS and SARA, with the ability to detect the remote flaws of the hosts on the network and their local flaws and missing patches as well—whether they are running Windows, Solaris, Mac OS X or a Unix-like system.

Common Vulnerabilities and Exposure Remediation Engine—this engine is a common vulnerabilities and remediation engine. This engine will allow for both automated and on-demand methods of remediating and related security vulnerabilities that have been found on assets in the network. This will include scripts and macros and other similar methods used to remove vulnerabilities from the network. Common vulnerabilities and remediation engine variations include functionality to allow customers to select which IP Addresses need to be repaired by the removal of the Common Vulnerability and Exposure (CVE) which has been discovered. The Workflow component of the CVE-REMEDY system enables end users to accept CVE repairs and if a client or agent exists on the network asset that contains a or other related CVE, a connection is made to the client to initiate a patch or system reconfiguration and resolve the and related CVE.

Reporting System—this is a reporting system engine which generates reports in various formats providing information to the user about vulnerabilities on their system, methods of remediating these vulnerabilities, assets on their network, updates to their system, compliance with regulations as well as any pertinent information about the state of their network. Reporting system engine variations include centralized reporting, easily customizable reports for flexible reporting, automated trending and differential reports for gap analysis, remediation reporting for the workflow engine including ticket trending and tickets by group, user, and vulnerability as well as web-based reporting immediately available to authorized users. Reports may be output in PDF, XML, CSV, XLS, HTML, and other industry standard report formats.

Subscription, Updates and Licensing System—this is a subscription, updates and licensing system which provides the end-user a method of obtaining the latest vulnerability tests, code updates and in general any subscription updates they have paid for. This system provides a licensing system so that these updates can be properly managed by the provider. This system will be composed of a server engine on a publicly hosted site and a client-engine on each appliance. The server engine will contain a database, a license manager and all vulnerability tests, code updates and subscription data and files pertinent to the subscription service. The client engine will contain a secure mechanism to request updates from the server as well as a mechanism to change the license available to the end-user. Subscription, updates and licensing system variations include built-in functionality to connect to the subscription server and obtain various pieces of information including subscription start date confirmation, subscription end date confirmation, options to expand current subscription and an e-commerce component to enable instant one-click purchasing of subscription updates. The SULS also allows end customers to obtain soft updates for any functionality that has been improved or changed in the system and help ensure currency through timely updates of the Vulnerability Management and Intrusion Prevention system.

Countermeasure Communications System—the Countermeasure Communications engine shares dynamically detected information about current and new network assets for the dynamic reconfiguration of ready firewalls, virtual private networks (VPNs) and SmartSwitches to quarantine and related CVEs (problems) detected in any and all trusted network assets at the port level, blocking problems at ports, not people and productivity. In the event a network asset is untrusted, such as a rogue enabled wireless device, laptop or wireless router, it is quarantined at all possible points of entry and exit including but not limited to the firewall, VPN, ids, ips and SmartSwitch. This system will also send an alert through E-mail and SMS paging to an IT Manager or designated end user to let them know that the system detected a rogue or high risk asset and took action, automatically.

Logging system: A logging system which provides the end-user with data of the activities on the security appliance. This includes system, user and event logs. The system logs comprise, but are not limited to, issues related to the hardware, software, services and network, and any changes that may occur to these components, whether through user interaction, automated functionality, system failure or any other means. The user logs comprise, but are not limited to, activities instigated by an end-user. This includes any access to the product and subsequent activity performed by that user. User logging will also include tracking of concurrent users accessing the product, when any access occurred, failed login attempts and any unauthorized activity. Event logging includes any operating system related issues, reboots, shutdowns. Also update activities including the vulnerability test updates, code updates, subscription service updates, license upgrades and related activities.

Database integration engine with workflow: This engine is based on a Relational Database engine which consists of a workflow control system, ticketing control system, tracking and verification system which integrate reporting, asset, workflow and logging databases of the security appliance. It uses data warehouse methodologies to correlate data from numerous sources via a command center. The workflow control system sets up, distributes and manages the overall workflow process. The ticketing control system assigns workflow activities to customer defined resources, assigns priorities and escalates priorities as needed. The tracking and verification system keeps a status of the workflow process, provides reports and alerts and finalizes completed workflow activities. The database integration leverages drivers with ODBC (Open DataBase Connectivity), JDBC (Java Database Connectivity), UDBC (Universal Database Connection) and OLE DB & CROSS to fully integrate the underlying databases with the applications running on the system.

Scheduling and configuration engine: The scheduling and configuration engine controls any process on the product which pertains to scheduled activities or the configuration of the system, audits or any processes running on the product. This includes but is not limited to the auto-update process for obtaining vulnerability tests, subscription updates or code updates. It also includes auditing and reporting processes, workflow, network discovery, dashboard, command center, and logging processes of the security appliance.

Network enabled device, Wireless and other related mobile devices/asset detection and management engine: The Internet or Network enabled device, wireless and mobile devices/asset detection and management engine includes a, wireless access point and mobile device discovery system which links into the notification engine, countermeasure engine and database engine. This discovery engine detects systems through various means including network scanners such as Nmap, Nessus, SARA, DHCP broadcasts, traffic analyzers and SNMP traps and other similar tools. The engine sends alerts through the alerting engine relating data about the existence and state of wireless and mobile devices discovered. This engine also interacts with the countermeasure engine, providing a means to quarantine and/or control the flow of traffic to and from the wireless and mobile devices. This includes traffic control via firewalls, smartswitches, VPNs and similar technology. This engine also interacts with the database engine to store and track all data related to wireless and mobile assets.

Notification engine: The notification engine interacts with all components of the system to provide notifications, alerts and status based on the activity of the product. This includes but is not limited to data from the update engine (vulnerability tests updates, code updates, subscription updates, etc.), reporting engine, logging engine, workflow engine, network discovery, asset engines and wireless and mobile devices/asset detection and management engine. Notification is provided through email, SMS messages, cell phone alerts, pager messages and similar such communication media to ensure timely alerts about related security issues.

Regulatory compliance reviewing and reporting system: The regulatory compliance reviewing and reporting system is an engine which combines the corporate security policy, government regulations, business security programs, vulnerability assessment, malicious traffic inspection and reporting features of the product into an integrated system for assessing and reporting the status of assets as they pertain to regulatory compliance. The engine ties regulations, company policies and security programs to assets and to vulnerability tests in order to ascertain the level of compliance with these regulations, policies and programs. This engine leverages the data obtained through the vulnerability assessment engine to assess the level of compliance. Automated actions ensue from these results in conjunction with the countermeasure engine to ensure the security of assets as well as compliance with policies and regulations. The engine provides related data to the alerting engine. The engine also provides data to the reporting and database correlation and warehouse engines.

Database Correlation and Warehousing Engine: This engine gathers data from processes and results throughout the product as well as from internal/external resources, including but not limited to the Update Servers, Countermeasure appliances, RSS Data feeds, other devices of the same nature as this patent describes and any related third party sources. The engine uses data warehouse methodologies to store this data. The engine also provides a means of querying the database and warehouse information either through automated methods or through on-demand user interfaces.

Clientless network admission control system: This engine provides a means to control the access of computer equipment and related network devices onto networks. The engine does not require any software to be installed on any of the target devices. The engine uses a combination of the network discovery engine, vulnerability assessment engine, database correlation engine, wireless and mobile device detection engine to determine when a network device has permission to access the network. This determination is also based upon information obtained from the regulatory compliance reviewing and reporting system and policies. This engine interacts with the countermeasure communications system to control the access of each network appliance. The engine is designed to work in a multi-branch solution and provide extensible authorization. It securely connects to ready and industry standard firewalls, smartswitches, IDS, IPS and VPNs to reconfigure their rules and access control lists around and related CVE related problems and ports, not people and productivity.

Graphical user interface that displays reports and real time analysis from data gathered by multiple RSS Feed-based Security Software and Appliances: This engine provides a means to gather data in a multi-branch environment from numerous Security devices; correlate this data; and display data, trends, status and real time analysis of this data. It provides a means to query from an updated data warehouse to provide user defined reports and information. It also provides a means to remotely manage the Security devices. This engine provides a network summary including but not limited to missing network devices, vulnerability counts, interactions with countermeasures and status of the vulnerability tests, and code and subscription updates across the multi-branch environment.

The graphical user interface (GUI) provides connections to all components of the appliance. It is the means in which the end-user has access to control the functionality of the appliance. The security access control (AUTH) is connected to the graphical user interface (GUI) to allow security controls over how an end-user may access the appliance. It also interacts with the reporting system (REPORTS) to provide encryption capabilities for access to reports and sensitive data. It is also connection to the database engine (DBIE) so that all access to the appliance can be tracked and monitored. The secure communications sub-system (SEC-COMM) is connected to the subscription service (SULS) providing a secure means in which vulnerability tests can be added to the appliance as well as updating the license of the end-user and providing any upsell or functional enhancements to the appliance. It is also connected to the database engine (DBIE) so that all secure transactions through this component can be tracked and monitored. The network and asset discovery and mapping engine (NAADAMS) is interconnected with the asset management engine (AME), providing the data necessary for this component as well as with the database engine. Other components are CVE-DISCOVERY, a common vulnerabilities and discovery engine; CVE-REMEDY, a common vulnerabilities and remediation engine; REPORTS, a reporting system; SULS, a subscription, updates and licensing system; COUNTERMEASURE-COMM, a countermeasures communication system; LOGS), a logging system; DBIE, a database integration engine; SCHED-CONFIG, a scheduling and configuration engine; -WIRELESS-MOBILE, a wireless and mobile devices/asset detection and management engine; NOTIFY, a notification engine, and REG-COMPLY, a regulatory compliance reviewing and reporting system.

A graphical user interface that displays reports and real time analysis from data gathered by multiple Vulnerability Management and Intrusion Prevention Systems and the Structural Functions of the Command Center—The graphical user interface (GUI) provides connections to all components of the appliance. It is the means in which the end-user has access to control the functionality of the appliance. The security access control (AUTH) is connected to the graphical user interface (GUI) to allow security controls over how an end-user may access the appliance. It also interacts with the reporting system (REPORTS) to provide encryption capabilities for access to reports and sensitive data. It is also connection to the database engine (DBIE) so that all access to the appliance can be tracked and monitored. The secure communications sub-system (SEC-COMM) is connected to the subscription service (SULS) providing a secure means in which vulnerability tests can be added to the appliance as well as updating the license of the end-user and providing any upward selling or functional enhancements to the appliance. It is also connected to the database engine (DBIE) so that all secure transactions through this component can be tracked and monitored. The network and asset discovery and mapping engine (T-U-S-NAADAMS) is interconnected with the asset management engine (AME) providing the data necessary for this component as well as with the database engine(AME) An asset management engine (CVE-DISCOVERY) A common vulnerabilities and discovery engine (CVE-REMEDY) A common vulnerabilities and remediation engine(REPORTS) A reporting system (SULS) A subscription, updates and licensing system(COUNTERMEASURE-COMM) A countermeasures communication system(LOGS) A logging system(DBIE) A database integration engine(SCHED-CONFIG) A scheduling and configuration engine (WIRELESS-MOBILE) A wireless and mobile devices/asset detection and management engine(NOTIFY) A notification engine(REG-COMPLY) A regulatory compliance reviewing and reporting system.

The system is designed around a number of engines which work together to provide state of the art vulnerability assessment, malicious traffic inspection, reporting, management, and remediation-capabilities through software package deployments or on network appliance platforms of various shapes and sizes. Other than a one time setup interface over a serial connection to a HyperTerminal interface, the appliance is a headless device where the end-user interface is through a secure web interface. Data is stored in both a flat-file format and a secure relational database server. The vulnerability assessment component is based on an intelligent scan engine which scans network assets for flaws and weaknesses in the systems. A network discovery engine provides a means to determine the assets on a network both through on-demand means initiated by an end-user and through dynamic detection as assets appear on the network. Vulnerability and asset data is stored in the appliance and reporting results are auto-generated and provided on demand through a query interface. Vulnerable systems are quarantined from the network through a countermeasure engine which interacts with firewalls, smartswitches and other similar devices. All vulnerability data is passed to a workflow engine which allows the end-user to assign remediation needs to resources, track the status and escalate the status as needed. A notification engine is tied in to all processes providing the end-user instant information on the status of the network and the components in the appliance. A dashboard and command center allows the user an easy interface to manage and review the status of the entire network and assets whether they are local or in remote locations. A logging engine collects all pertinent data about the system, user access, functionality and processes on the appliance.

As to a further discussion of the manner of usage and operation of the present invention, the same should be apparent from the above description. Accordingly, no further discussion relating to the manner of usage and operation will be provided.

With respect to the above description then, it is to be realized that the optimum dimensional relationships for the parts of the invention, to include variations in size, materials, shape, form, function and manner of operation, assembly and use, are deemed readily apparent and obvious to one skilled in the art, and all equivalent relationships to those illustrated in the drawings and described in the specification are intended to be encompassed by the present invention.

Therefore, the foregoing is considered as illustrative only of the principles of the invention. Further, since numerous modifications and changes will readily occur to those skilled in the art, it is not desired to limit the invention to the exact construction and operation shown and described, and accordingly, all suitable modifications and equivalents may be resorted to, falling within the scope of the invention.

1. A device comprising:
a first communications interface to a wide area network;
a second communications interface to a corporate network;
a processor executing a security engine, the security engine adapted to communicate over the corporate network to perform a security audit, scan the corporate network for attached devices, dynamically detect changes to attached devices, and prepare a network based asset list, the security engine further adapted to reconfigure INFOSEC countermeasures based upon at least one cyber-threat and at least one vulnerability profile of a network based asset in the network based asset list, and the security engine further adapted to communicate over the wide area network to received updated security tests and provide updates to a remote location;
a memory storing the network based asset list; and
an appliance housing substantially enclosing the first communications interface, the second communications interface, the processor, and the memory.

2. The device of claim 1 wherein the at least one cyberthreat includes a local cyber-threat.

3. The device of claim 1 wherein the at least one cyberthreat includes a global cyber-threat.

4. The device of claim 1 wherein the INFOSEC countermeasures include one or more of a firewall, and anti-virus system, an anti-spyware system, a virtual private networking system, an intrusion detection system, an intrusion prevention system, a router, and a smart-switch.

5. The device of claim 1 wherein the remote location includes an INFOSEC server.

6. The device of claim 1 wherein the wide area network is the Internet.

7. The device of claim 1 wherein the wide area network includes a private area network.

8. The device of claim 1 wherein the wide area network includes a campus network.

9. The device of claim 1 wherein the corporate network includes a local area network.

10. The device of claim 1 wherein the corporate network includes a virtual private network.

11. The device of claim 1 wherein the corporate network includes a wireless network.

12. The device of claim 1 wherein the security engine is adapted to update one or more regulatory compliance tests.

13. The device of claim 1 wherein the security engine is adapted to operate as a standalone network security device.

14. The device of claim 13 further comprising an interface engine executing on the processor that provides an executive dashboard for user access.

15. The device of claim 13 further comprising an interface engine executing on the processor that provides an administrative dashboard employing data received from the device.

16. The device of claim 1 wherein the security engine is adapted to operate as a remote network security device, the security engine adapted to communicate over the wide area network with a centralized security management facility.

17. The device of claim 16 wherein the centralized security management facility provides an administrative dashboard employing data received from the device.

18. The device of claim 17 wherein the administrative dashboard includes a secure sockets layer, secure hypertext transport protocol, graphical user interface for system administrators.

19. The device of claim 16 wherein the centralized security management facility provides an executive dashboard employing data received from the device.

20. The device of claim 19 wherein the executive dashboard includes a secure sockets layer (SSL), secure hypertext transport protocol (HTTPS), graphical user interface (GUI) for predetermined executives.

21-50. (canceled)
